(19) United States
(12) Patent Application Publication
(10) Pub. No.: US 2012/0017766 A1
(43) Pub. Date: Jan. 26, 2012

(54) WATER CONTAINER CAP WITH FILTER FOR HOLDING ADDITIVES TO WATER

(76) Inventors: Ricky L. Anson, Boise, ID (US); Rebecca L. Anson, Boise, ID (US); Shane Jimenez, Boise, ID (US)

(21) Appl. No.: 13/005,082

(22) Filed: Jan. 12, 2011

Related U.S. Application Data
(60) Provisional application No. 61/325,577, filed on Apr. 19, 2010.

(51) Int. Cl. A47J 31/44; B01D 35/02

(52) U.S. Cl. 99/290; 210/467; 210/232

(57) ABSTRACT

A supplement dispensing closure couplable to an outlet of a container, such as a water container. When the closure is coupled to the container, liquid exiting the container through the outlet flows through a supplement retention area that retains a dissolvable supplement body inside the closure as the liquid flows therethrough and dissolves the dissolvable supplement body. A user may select one or more dissolvable supplement bodies and insert them inside the supplement retention area for dissolution in the liquid as it flows through the supplement retention area. The closure may include a selectively openable and closable cap portion. The closure includes a selectively removable filter assembly configured to filter one or more components from the liquid before or after it flows through the supplement retention area.

### BACKGROUND OF THE INVENTION

1. Field of the Invention

The present invention is directed generally to a cap for use with a water container and, more specifically, to a container cap assembly including a filter in which an additive or supplement tablet may be placed for dissolution in water as it is poured from the container.

2. Description of the Related Art

It is often desirable to purchase water to which various additives have been added. These additives may include nutrients, minerals, vitamins, colorings, flavorings, medicinal materials, herbal remedies, chemicals, and the like. The additives are often supplied with the water itself (e.g., supplements may be dissolved or suspended in the water) and sold as water designed for a certain task. A disadvantage of water prepared with an additive (i.e., a pre-mixed water/supplement mixture) is that the container housing the water is typically disposable, and after being utilized, typically becomes waste. The pre-mixed water/supplement mixture may also have to be transported for a long distance, which adds greatly to the cost of the product. Further, many nutrients lose their effectiveness after being immersed in water for a period of time.

A need exists for a method for preparing supplemented liquids that avoids pre-mixing the supplement in the liquid. A need also exists for a device for conveniently preparing supplementing liquids at the point of consumption. It would be desirable for the device to introduce the supplement into only a portion of liquid poured from a container for consumption. The present application provides these and other advantages as will be apparent from the following detailed description and accompanying figures.

### BRIEF DESCRIPTION OF THE SEVERAL VIEWS OF THE DRAWING(S)

FIG. 1 is a cut-away perspective view of the container cap assembly of the invention.

FIG. 2 is a perspective view of the container cap top and tablet basket.

FIG. 3 is an exploded perspective view of an embodiment of a supplement dispensing closure for use with a container housing a liquid.

FIG. 4 is an exploded cross-sectional view of a supplement housing portion and a cap portion of the supplement dispensing closure of FIG. 3.

FIG. 5 is an exploded perspective view of an embodiment of the supplement dispensing closure of FIG. 3 including an optional threaded filter that threads into the supplement housing portion.

FIG. 6 is an exploded perspective view of an embodiment of the supplement dispensing closure of FIG. 3 including an optional filter that snaps into the cap portion.

FIG. 7 is an exploded perspective view of an alternate embodiment of a supplement housing portion of a supplement dispensing closure for use with a container having a threaded neck portion with internal threads.

FIGS. 8A and 8B are top and bottom exploded perspective views of a supplement housing portion of a supplement dispensing closure including a selectively removable filter.

FIG. 9 is a bottom exploded perspective views of the supplement housing portion shown in FIGS. 8A and 8B using another embodiment of a selectively removable filter.

FIG. 10 is a top perspective view of the selectively removable filter shown in FIG. 9.

FIG. 11A is a top exploded perspective view of a filter housing that is selectively couplable to the supplement housing portion.

FIG. 11B is a bottom exploded perspective view of the filter housing that is selectively couplable to the supplement housing portion.

FIG. 12A is a top perspective view of the filter housing and the supplement housing portion shown in FIGS. 11A and 11B, wherein the filter housing is in an assembled configuration and is unattached to the supplement housing portion.

FIG. 12B is a bottom perspective view of the filter housing and the supplement housing portion shown in FIGS. 11A and 11B, wherein the filter housing is in an assembled configuration and is unattached to the supplement housing portion.

FIG. 13A is a bottom perspective view of the filter housing and the supplement housing portion shown in FIGS. 11A and 11B, shown in a fully assembled position.

FIG. 13B is a side cross-sectional view of the assembled filter housing and the supplement housing portion shown in FIG. 13A, wherein disposable filters are positioned within the filter housing.

FIG. 14A is a top perspective view of another filter housing that is selectively couplable to the supplement housing portion.

FIG. 14B is a bottom perspective view of the filter housing shown in FIG. 14A.

FIG. 14C is a top plan view of the filter housing shown in FIG. 14A.

FIG. 14D is a bottom plan view of the filter housing shown in FIG. 14A.

FIG. 14E is a side elevational cross-sectional view of the filter housing shown in FIG. 14A.

FIG. 14F is an exploded top perspective view of the filter housing shown in FIG. 14A when the filter is in an assembled condition.

FIG. 14G is an exploded top perspective view of the filter housing shown in FIG. 14A when the filter is in an unassembled condition.

FIG. 14H is an exploded bottom perspective view of the filter housing shown in FIG. 14A when the filter is in an unassembled condition.

FIG. 15A is a top perspective view of another filter housing that is selectively couplable to the supplement housing portion.

FIG. 15B is a bottom perspective view of the filter housing shown in FIG. 15A.

FIG. 15C is a side elevational cross-sectional view of the filter housing shown in FIG. 15A.

FIG. 15D is an exploded top perspective view of a filter of the filter housing shown in FIG. 15A.

FIG. 15E is a top perspective view of the filter of the filter housing shown in FIG. 15A.

FIG. 15F is a bottom perspective view of the filter of the filter housing shown in FIG. 15A.

FIG. 15G is a side elevational view of the filter of the filter housing shown in FIG. 15A.

FIG. 16A is an exploded top perspective view of another filter housing that is selectively couplable to the supplement housing portion.

FIG. 16B is an exploded bottom perspective view of the filter housing shown in FIG. 16A.

FIG. 16C is an exploded top perspective view of the filter housing shown in FIG. 16A when its filter is in an assembled condition.

FIG. 16D is a top perspective view of the filter housing shown in FIG. 16A.

FIG. 16E is a bottom perspective view of the filter housing shown in FIG. 16A.

FIG. 16F is a top plan view of the filter housing shown in FIG. 16A.

FIG. 16G is a bottom plan view of the filter housing shown in FIG. 16A.

FIG. 17A is an exploded top perspective view of another filter housing that is selectively couplable to the supplement housing portion.

FIG. 17B is an exploded bottom perspective view of the filter housing shown in FIG. 17A.

FIG. 17C is an exploded top perspective view of the filter housing shown in FIG. 17A when its filter is in an assembled condition.

FIG. 17D is a top plan view of the filter housing shown in FIG. 17A.

FIG. 17E is a bottom plan view of the filter housing shown in FIG. 17A.

FIG. 18A is a top perspective view of another embodiment of a filter assembly.

FIG. 18B is a bottom perspective view of the filter assembly shown in FIG. 18A.

FIG. 18C is an exploded top perspective view of the filter assembly shown in FIG. 18A.

FIG. 19A is an exploded top perspective view of another filter housing that is selectively couplable to the supplement housing portion.

FIG. 19B is an exploded bottom perspective view of the filter housing shown in FIG. 19A.

FIG. 19C is a side elevational cross-sectional view of the filter housing shown in FIG. 19A.

### DETAILED DESCRIPTION OF THE INVENTION

While the invention is susceptible of various modifications and alternative constructions, certain illustrated embodiments thereof have been shown in the drawings and will be described below in detail. It should be understood, however, that there is no intention to limit the invention to the specific forms disclosed, but, on the contrary, the invention is to cover all modifications, alternative constructions, and equivalents falling within the spirit and scope of the invention as defined by the claims.

In the following description and in the figures, like elements are identified with like reference numerals. The use of “or” indicates a non-exclusive alternative without limitation unless otherwise noted. The use of “including” means “including, but not limited to,” unless otherwise noted.

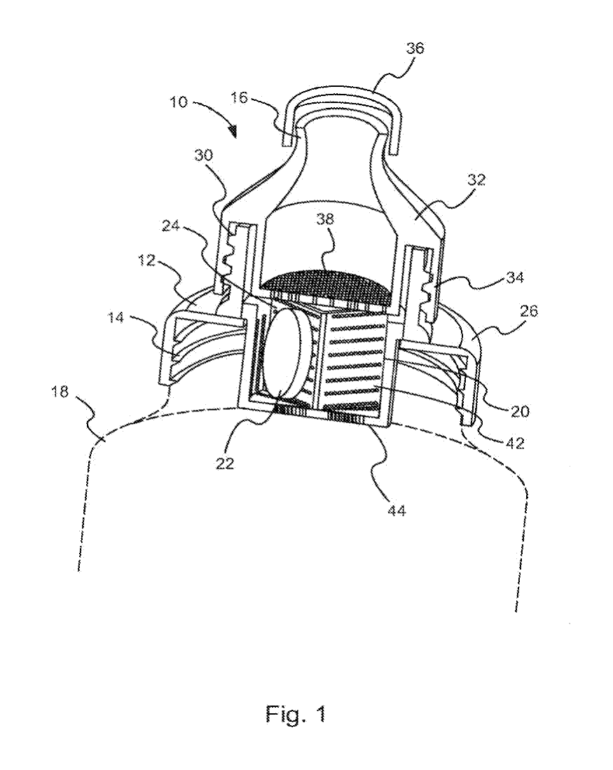

FIG. 1 shows a first embodiment of the invention. This embodiment shows a container cap assembly 10 attached to a container 18. The container cap assembly 10 includes a cap body 12 made up of a cap base 26 and a cap top 32. The cap base 26 includes a connection 30 to the cap top 32 and a container fitting interface 14. The cap base 26 also includes a tablet basket 20 holding a tablet 22. Inside the tablet basket 20 are dividers 42 in which different tablets 22 may be placed. The cap top 32 includes a connection 34 to the cap base 26, a closure cap 36, and a basket closure 38. The basket closure 38 is a disc like surface with a number of perforations. When screwed together, the basket closure 38 seals off the tablet basket 20 and allows water to flow through the container cap assembly 10 but keeps the tablet 22 from leaving the container cap assembly. The tablet basket 20 includes perforations 44 for allowing water within the container 18 to flow out the container cap assembly 10.

Although shown as a two-piece unit, with the tablet basket 20 being openable for refilling, the container cap assembly 10 can also be configured as a one-piece unit, supplied with one or more tablets 22, without the ability for refilling. The version shown in FIG. 1 has a tablet access port 24 which is exposed when the cap top 32 is removed from the cap base 26.

The closure cap 36 can also take a number of forms, including a pull-up closure valve 16 or other conventional water container closure mechanisms. These can include a handle which twists to open the passage for water to exit the cap top 32 or other conventional water container dispensing enclosure caps and valves.

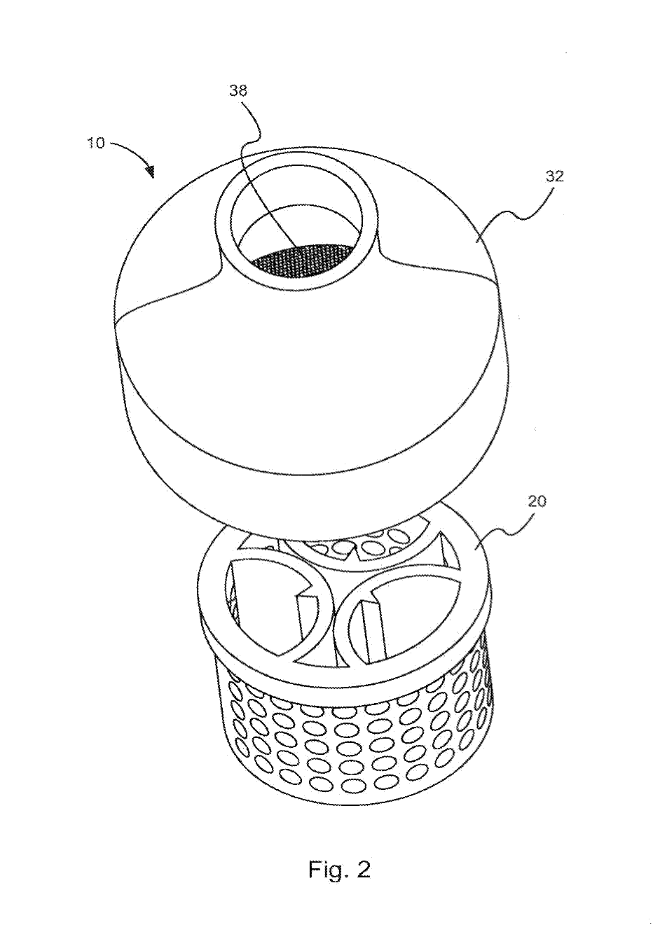

Shown in FIG. 2 is a perspective view of the cap top 32 and the tablet basket 20. Viewable through the top opening of the cap top 32 is the perforated basket closure 38 portion of the cap top, which prevents the tablets 22 (see FIG. 1) from exiting the tablet basket 20.

### Alternate Embodiment

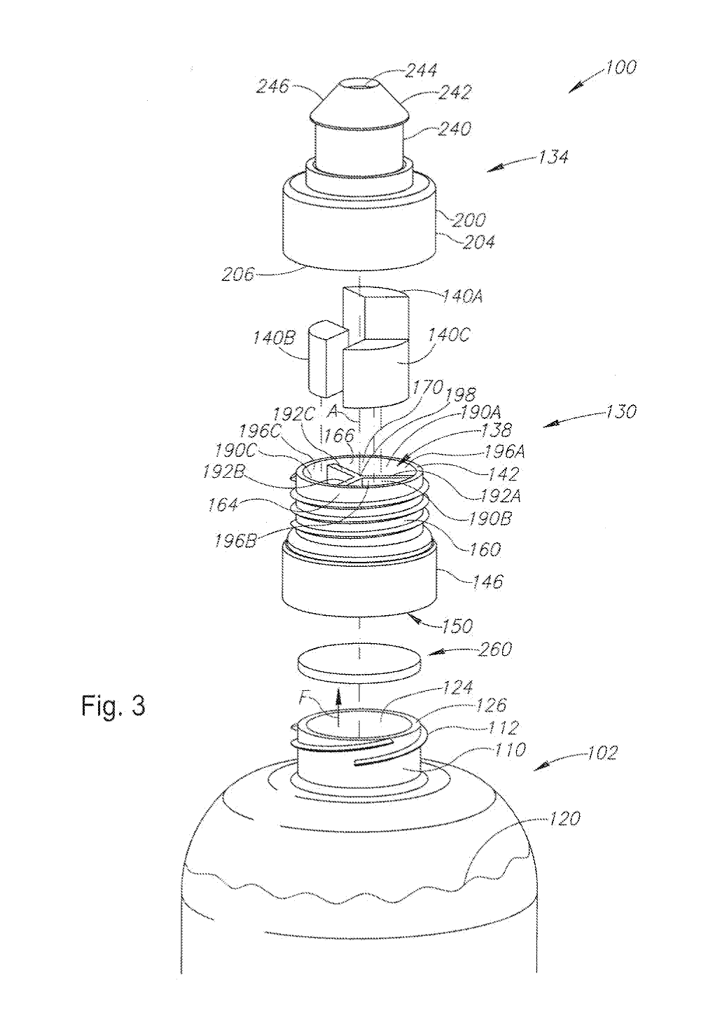

FIG. 3 illustrates a second embodiment of a supplement dispensing cap or closure 100 for use with a container 102 (such as a water bottle). The container 102 may be implemented as any conventional beverage container known in the art, including as a blow molded bottle or a larger liquid container. In the embodiment illustrated, the container 102 has a threaded neck portion 110 with outside threads 112 disposed thereabout. The container 102 houses or stores a liquid 120. The liquid 120 may be any beverage including commercially available beverages such as bottled water, GATORADE®, KOOL-AID®, and the like or simply tap water. By way of non-limiting examples, the liquid 120 may include water, soda, fruit juice, vegetable juice, dairy products, and combinations thereof. The liquid 120 stored in the container 102 exits therefrom through an outlet 124. In the embodiment illustrated, the outlet 124 is formed in an open distal portion 126 of the threaded neck portion 110 of the container 102.

The closure 100 includes a supplement housing portion 130 and a cap portion 134 that together define a supplement retention area 138 in which one or more dissolvable supplement bodies (e.g., dissolvable supplement bodies 140A, 140B, and 140C) are retained as the liquid 120 is poured from the container 102 through the outlet 124 and into the supplement housing portion 130 along a flow direction indentified by a single headed arrow “F.” The dissolvable supplement bodies 140A, 140B, and 140C are dissolved by the liquid 120 as it flows through the supplement retention area 138. A flow rate of the liquid 120 through the supplement retention area 138 may be based at least in part on a dissolve rate of the one or more dissolvable supplement bodies 140A, 140B, and 140C in the liquid 120 as it flows through the supplement retention area 138 at the flow rate. The dissolved portions of the dissolvable supplement bodies 140A, 140B, and 140C combine with the liquid 120 to form a supplemented liquid to be consumed by a user, typically as it exits the closure 100.

The dissolvable supplement bodies 140A, 140B, and 140C may include one or more nutrients, minerals, vitamins, dietary supplements, sleep aids, weight loss products, energy enhancers, wellness products, colorings, flavorings, medicinal materials, herbal remedies, chemicals, combinations thereof, and the like. The dissolvable supplement bodies 140A, 140B, and 140C may be selected to produce a particular supplemented liquid. By way of non-limiting examples, the dissolvable supplement bodies 140A, 140B, and 140C may be selected to produce an energy drink, a sports drink, a wellness drink, a protein drink, a weight loss drink, a multivitamin drink, an appetite suppressing drink, a sleep aid, and the like, or a combined purpose drink. In other words, depending upon the supplement bodies 140A, 140B, and 140C selected, the same liquid 120 may be transformed into any one of a number of possible supplemented liquids. When the liquid 120 includes an adequate portion of water, the supplemented liquid may retain its hydrating properties while delivering dissolved supplements to the user.

The supplement housing portion 130 has an outer sidewall 142 that may be generally symmetric about a central axis “A.” For example, the outer sidewall 142 may have a generally cylindrical shape with a circular cross-sectional shape. In the embodiment illustrated, the central axis “A” is substantially parallel to the flow direction (indentified by arrow “F”) and the supplement housing portion 130 is elongated along the central axis “A.” However, these are not requirements. Further, the outer sidewall 142 need not be symmetric about the central axis “A.” For example, implementations in which the outer sidewall 142 defines a supplement housing portion having a curved or bent shape are within the scope of the present disclosure.

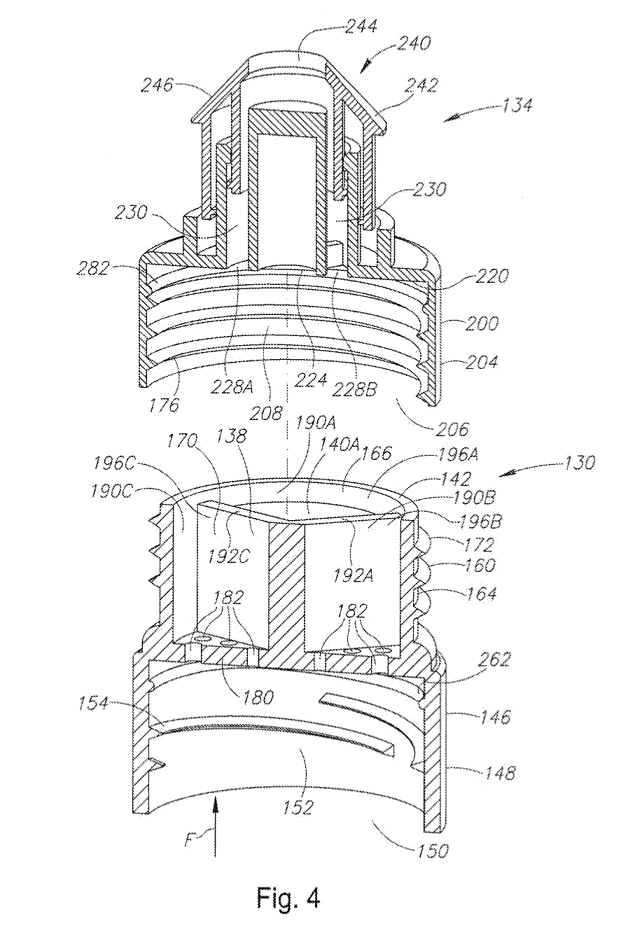

The supplement housing portion 130 has a first connector portion 146 couplable to the outlet 124 of the container 102. In the embodiment illustrated, the outlet 124 is formed in the open distal portion 126 of the threaded neck portion 110 of the container 102. Turning to FIG. 4, the first connector portion 146 is formed in a lower portion 148 of the outer sidewall 142, which defines an open lower portion 150 in communication with a hollow interior portion 152. The open lower portion 150 is configured to allow the threaded neck portion 110 (see FIG. 3) of the container 102 (see FIG. 3) to pass therethrough into the hollow interior portion 152 of the first connector portion 146. In this manner, the outlet 124 (see FIG. 3) of the container 102 (see FIG. 3) is received inside the hollow interior portion 152 to allow the liquid 120 (see FIG. 3) to be poured from the container through the outlet into the supplement housing portion.

In the embodiment illustrated, the first connector portion 146 includes inside threads 154 disposed on the inside of the lower portion 148 of the outer sidewall 142 configured to threadably engage the outside threads 112 (illustrated in FIG. 3) of the threaded neck portion 110 (see FIG. 3) of the container 102 (see FIG. 3) to removably secure the closure 100 to the container in a fluid tight manner.

The supplement housing portion 130 has a second connector portion 160 couplable to the cap portion 134. The second connector portion 160 is formed in an upper portion 164 of the outer sidewall 142, which defines an open upper portion 166 in communication with a hollow interior portion 170 of the supplement housing portion 130. In the embodiment illustrated, the second connector portion 160 has outside threads 172 disposed on the outside of the upper portion 164 of the outer sidewall 142 configured to threadably engage inside threads 176 disposed inside the cap portion 134 to removably secure the cap portions to the supplement housing portion 130.

When the cap portion 134 is coupled to the second connector portion 160 of the supplement housing portion 130, the supplement retention area 138 is defined between the cap portion 134, the inside of the outer sidewall 142, and a perforated supplement support platform 180 located between the open upper portion 166 and the open lower portion 150. The perforated supplement support platform 180 may be transverse to the flow direction (identified by the arrow “F”). In the embodiment illustrated, the perforated supplement support platform 180 is located between the first and second connector portions 146 and 160. However, this is not a requirement and embodiments in which the perforated supplement support platform 180 is located within either of the first and second connector portions 146 and 160 are within the scope of the present teachings.

As is appreciated by those of ordinary skill in the art, an extended plug type seal (not shown) typically includes continuous ring-shaped projection that extends away from a support surface, such as the inside upper surface of a cap. Optionally, an extended plug type seal (not shown) may extend from the perforated supplement support platform 180 toward the open lower portion 150. When the first connector portion 146 of the supplement housing portion 130 is coupled to the outlet 124 (see FIG. 3) of the container 102 (see FIG. 3), the outlet 124 is received inside the hollow interior portion 152 of the first connector portion 146, and the extended plug type seal (not shown) extends into the open distal portion 126 of the outlet 124 to form a liquid tight seal between the supplement housing portion 130 and the outlet 124.

The dissolvable supplement bodies 140A, 140B, and 140C (see FIG. 3) may be inserted into the supplement retention area 138 via the open upper portion 166 when the cap portion 134 is removed from the supplement housing portion 130. FIG. 4 illustrates one of the dissolvable supplement bodies 140A housed or nested inside the supplement retention area 138. The perforated supplement support platform 180 includes perforations 182 that allow the liquid 120 (see FIG. 3) in the hollow interior portion 152 of the first connector portion 146 received from the outlet 124 (see FIG. 3) of the container 102 (see FIG. 3) to flow into the supplement retention area 138 when the container 102 is sufficiently tipped. Additionally, the perforations 182 allow the liquid remaining in the closure 100 to flow back into the container 102 when placed in an upright position. Optionally, the perforated supplement support platform 180 may be coated with a coating (not shown) configured to filter one or more components from the liquid 120 (see FIG. 3) before it enters the supplement retention area 138.

The liquid 120 (see FIG. 3) flowing through the perforations 182 into the supplement retention area 138 flows past the dissolvable supplement bodies 140A, 140B, and 140C (see FIG. 3) at least partially dissolving them at the dissolve rate to form the supplemented liquid, which exits the supplement retention area 138 through the open upper portion 166. If the cap portion 134 is coupled to the second connector portion 160 of the supplement housing portion 130, the supplemented liquid exiting the open upper portion 166 enters the cap portion 134.

In the embodiment illustrated, the supplement retention area 138 is disposed inside the hollow interior portion 170 of the second connector portion 160; thus, the outside threads 172 extend along the outside of the upper portion 164 of the outer sidewall 142, which is adjacent to the supplement retention area 138. However, this is not a requirement.

As best seen in FIG. 3, optionally, the supplement retention area 138 may be divided into a plurality of supplement chambers (e.g., supplement chambers 190A, 190B, and 190C) by one or more dividing walls (e.g., dividing walls 192A, 192B, and 192C). In the embodiment illustrated, the supplement housing portion 130 includes three supplement chambers 190A, 190B, and 190C separated from one another by dividing walls 192A, 192B, and 192C. The dividing wall 192A separates adjacent supplement chambers 190A, and 190B from one another. The dividing wall 192B separates adjacent supplement chambers 190B, and 190C from one another. The dividing wall 192C separates adjacent supplement chambers 190A, and 190C from one another.

The dividing walls 192A, 192B, and 192C are illustrated as extending upwardly from the perforated supplement support platform 180 (see FIG. 4) toward the open upper portion 166 along the flow direction (identified by arrow “F”). In such embodiments, the open upper portion 166 of the supplement retention area 138 is divided into open-end portions 196A, 196B, and 196C by the dividing walls 192A, 192B, and 192C. Thus, each of the supplement chambers 190A, 190B, and 190C has an open-end portion 196A, 196B, and 196C, respectively, configured to allow the dissolvable supplement bodies 140A, 140B, and 140C, respectively, to be inserted into the supplement chambers 190A, 190B, and 190C, respectively.

Each of the dividing walls 192A, 192B, and 192C is illustrated as extending from a portion of the inside of the upper portion 164 of the outer sidewall 142 toward a central portion 198 of the hollow interior portion 170 and meeting at the central portion. Thus, in the embodiment illustrated, the three dividing walls 192A, 192B, and 192C are attached together at the central portion 198. In embodiments in which the outer sidewall 142 is generally symmetric about the central axis “A,” the central portion 198 is located along the central axis “A.”

The cap portion 134 may be implemented as any selectively openable and closable cap known in the art. In the embodiment illustrated, the cap portion 134 has been implemented as a standard (push-pull type) sports cap. By way of a non-limiting example, the cap portion 134 may be implemented as a standard 28 mm sports type closure, a standard 26 mm sports type closure, or any other sports type closure. However, other types of caps or cap portions may be used. By way of other non-limiting examples, the cap portion 134 may be implemented as a cap having a hinged lid, twist-open sports cap, a cap with a spring-loaded lid, a twist cap that opens by twisting a twistable portion of a valve assembly, a “Sippy” top (i.e., a cap configured to be similar to a spill proof top found on a toddler's sip cup), and the like.

The cap portion 134 has a cap connector portion 200 couplable to the second connector portion 160 of the supplement housing portion 130. Turning to FIG. 4, the cap connector portion 200 includes a lower outer sidewall 204, which defines an open lower portion 206 in communication with a hollow interior portion 208. The lower outer sidewall 204 illustrated has a generally cylindrically shape having a circular cross-sectional shape. The open lower portion 206 is configured to allow the open upper portion 166 of the second connector portion 160 of the supplement housing portion 130 to pass therethrough into the hollow interior portion 208 of the cap connector portion 200. In this manner, the open upper portion 166 of the second connector portion 160 is received inside the hollow interior portion 208 of the cap connector portion 200 of the cap portion 134 to allow the liquid 120 to be poured from the supplement retention area 138 through the open upper portion 166 and into the cap portion 134.

As mentioned above, the cap portion 134 includes the inside threads 176 configured to engage the outside threads 172 of the second connector portion 160 disposed on the outside of the upper portion 164 of the outer sidewall 142 of the supplement housing portion 130. The inside threads 176 are disposed on the inside of the lower outer sidewall 204 of the cap connector portion 200. When the inside threads 176 of the cap portion 134 are mated with the outside threads 172 of the second connector portion 160 of the supplement housing portion 130, the open upper portion 166 of the second connector portion 160 (in fluid communication with the supplement retention area 138) is located inside the cap portion 134 allowing the liquid 120 (see FIG. 3) flowing from the open upper portion 166 of the second connector portion 160 (after having passed through the supplement retention area 138) to enter the cap portion 134.

As also mentioned above, the supplement housing portion 130 and the cap portion 134 together define the supplement retention area 138. The cap portion 134 includes an annular internal stop portion 220 disposed about a central portion 224 having one or more inlets 228A and 228B to a fluid flow channel 230.

When the cap portion 134 is coupled to the supplement housing portion 130, the annular internal stop portion 220 is adjacent the open upper portion 166 (and/or open-end portions 196A, 196B, and 196C depending upon the implementation details) of the second connector portion 160. Further, the inlets 228A and 228B are adjacent the central portion 198 (see FIG. 3) of the hollow interior portion 170 of the second connector portion 160 whereat the dividing walls 192A, 192B (see FIG. 3), and 192C meet.

The internal stop portion 220 helps retain the supplement bodies 140A, 140B (see FIG. 3), and 140C (see FIG. 3) inside the supplement retention area 138 when the supplement housing portion 130 and the cap portion 134 are tipped, or in the extreme, inverted, such as occurs when the container 102 (see FIG. 3) is tipped or inverted to pour the liquid 120 (see FIG. 3) out through the outlet 124 (see FIG. 3). The inlets 228A and 228B adjacent the central portion 198 (see FIG. 3) of the hollow interior portion 170 of the second connector portion 160 extend outwardly beyond the location of the intersection of the dividing walls 192A, 192B (illustrated in FIG. 3), and 192C to allow the liquid 120 (see FIG. 3) exiting the supplement chambers 190A, 190B, and 190C via the open-end portions 196A, 196B, and 196C, respectively, to flow into the fluid flow channel 230.

Further, a gap (not shown) may be defined between the upper portion 164 of the outer sidewall 142 of the supplement housing portion 130 and the internal stop portion 220 of the cap portion 134. In such embodiments, the liquid 120 (see FIG. 3) exiting the supplement chambers 190A, 190B, and 190C via the open-end portions 196A, 196B, and 196C, respectively, may flow through the gap and into the inlets 228A and 228B of the fluid flow channel 230 of the cap portion 134.

The liquid 120 flows past the internal stop portion 220 while at the same time, the supplement bodies 140A, 140B (see FIG. 3), and 140C (see FIG. 3) dissolving in the passing liquid 120 are held within the supplement retention area 138 by the internal stop portion 220.

In the embodiment illustrated, the fluid flow channel 230 extends upwardly away from the internal stop portion 220 along the flow direction (identified by arrow “F”) and is terminated by an optional valve assembly 240. The valve assembly 240 includes a slidable valve member 242 that is selectably transitional from an open position (illustrated in FIG. 4) to a closed position (not shown) and vice versa. When the slidable valve member 242 is in the open position, the liquid 120 (see FIG. 3) in the fluid flow channel 230 may exit the cap portion 134 through an exit aperture 244 in the valve assembly 240. On the other hand, when the slidable valve member 242 is in the closed position, the exit aperture 244 is closed and the liquid 120 (see FIG. 3) in the fluid flow channel 230 is retained inside the cap portion 134 by the valve assembly 240.

A distal portion 246 of the cap portion 134 may be configured to be received inside a user's mouth. In the embodiment illustrated, the valve assembly 240 is located at the distal portion 246 of the cap portion 134 and is receivable inside the mouth of the user. However, this is not a requirement.

While the fluid flow channel 230 has been illustrated as extending upwardly away from the internal stop portion 220 along the flow direction (identified by arrow “F”), those of ordinary skill in the appreciate that the fluid flow channel 230 may extend along a direction other than the flow direction (identified by arrow “F”) toward the optional valve assembly 240 and such embodiments are within the scope of the present disclosure. Further, through application of ordinary skill to the present teachings, the location of the fluid flow channel 230 and/or its inlets 228A and 228B may be modified and such embodiments are within the scope of the present disclosure. Further, the number of fluid flow channels and/or inlets may be modified.

The size of the dissolvable supplement bodies 140A, 140B (see FIG. 3), and 140C (see FIG. 3) may be determined at least in part by the size and shape of the supplement chambers 190A, 190B, and 190C, respectively. In the embodiment illustrated in FIG. 3, the supplement chambers 190A, 190B, and 190C each have generally pie or wedge shaped cross-sectional shape. Further, the shape and hence surface area of the dissolvable supplement bodies 140A, 140B, and 140C may be determined at least in part based on a desired dissolve rate. For example, a ratio of surface area to volume may be selected to achieve a desired dissolve rate. Because the solid yet dissolvable supplement bodies 140A, 140B, and 140C obstruct the flow of the liquid 120 through the supplement retention area 138, the supplement bodies may be configured to achieve at least a minimum desired flow rate or alternatively, at most a maximum desired flow rate. Thus, the shape of the dissolvable supplement bodies 140A, 140B, and 140C may be determined at least in part based on the desired flow rate of the liquid 120 through the supplement retention area 138. The dissolvable supplement bodies 140A, 140B, and 140C may have many shapes so long as providing the desired dissolve rate.

The closure 100 may include an optional filter 260 (see FIG. 3). The filter 260 may be receivable inside the open lower portion 150 of the first connector portion 146 of the supplement housing portion 130 and may optionally snap inside the hollow interior portion 152 (see FIG. 4). Turning to FIG. 4, the hollow interior portion 152 may include one or more optional filter retainer projection 262 extending inwardly from the inside surface of the lower portion 148 of the outer sidewall 142. The projection 262 is located between the perforated supplement support platform 180 and the inside threads 154. The filter 260 (see FIG. 3) may be pressed upwardly into the hollow interior portion 152 and forced upwardly past the projection 262 to removably secure the filter 260 in place. Once located between the perforated supplement support platform 180 and the projection 262, the filter 260 is prevented from exiting the hollow interior portion 152 through the open lower portion 150 by the projection 262.

The filter 260 may include perforations (not shown). Alternatively, the filter 260 may be implemented as a charcoal filter, a foam or ceramic filter, a combination of these, and the like. Further, the filter 260 may be implemented as a screen or other type of filtering or screening device. For example, the filter 260 may be implemented as a charcoal water filter, a water distiller, a ceramic water filter, a reverse osmosis filter, an ultraviolet water filter, and the like. The filter 260 filters one or more components from the liquid 120 (see FIG. 3) before it enters the supplement retention area 138. By way of a non-limiting example, the filter 260 may be coated with a coating (not shown) configured to filter one or more components from the liquid 120 (see FIG. 3) before it enters the supplement retention area 138. The filter 260 may also prevent any small pieces of one of the dissolvable supplement bodies 140A, 140B, and 140C from passing through one of the perforations 182 of the supplement support platform 180 and entering the container 102.

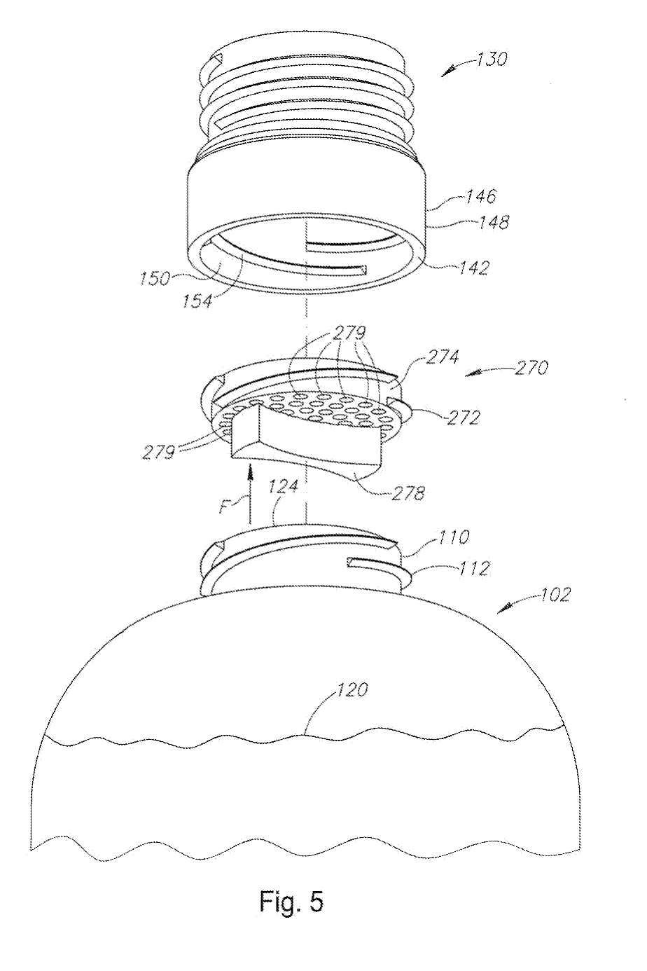

Turning to FIG. 5, the closure 100 (see FIG. 1) may include an optional threaded filter 270 having outside threads 272 disposed about its peripheral portion 274. The filter 270 may be receivable inside the open lower portion 150 of the first connector portion 146 of the supplement housing portion 130 and may threaded into the inside threads 154 disposed inside the lower portion 148 of the outer sidewall 142. The filter 270 may be threaded into the first connector portion 146 until it is adjacent to the perforated supplement support platform 180 (see FIG. 4). The filter 270 is prevented from exiting the hollow interior portion 152 through the open lower portion 150 by the threaded engagement of the outside threads 272 with the inside threads 154 of the supplement housing portion 130. In this embodiment, the optional filter retainer projection 262 may be omitted.

In the embodiment illustrated, the filter 270 includes a downwardly extending gripping projection 278. A user may grasp the gripping projection 278 to rotate the filter 270 to thread the outside threads 272 of the filter into the inside threads 154 of the supplement housing portion 130. After the filter 270 is threaded inside the first connector portion 146 of the supplement housing portion 130, the first connector portion 146 may be coupled to the outlet 124 of the container 102 by threading the outside threads 112 of the threaded neck portion 110 of the container 102 into the inside threads 154 of the supplement housing portion 130.

The filter 270 may include perforations 279. Alternatively, the filter 270 may be implemented as a charcoal filter, a foam filter or ceramic, a combination of these, and the like. Further, the filter 270 may be implemented as a screen or other type of filtering or screening device. For example, the filter 270 may be implemented as a charcoal water filter, a water distiller, a ceramic water filter, a reverse osmosis filter, an ultraviolet water filter, and the like. The filter 270 filters one or more components from the liquid 120 before it enters the supplement retention area 138. By way of a non-limiting example, the filter 270 may be coated with a coating (not shown) configured to filter one or more components from the liquid 120 before it enters the supplement retention area 138.

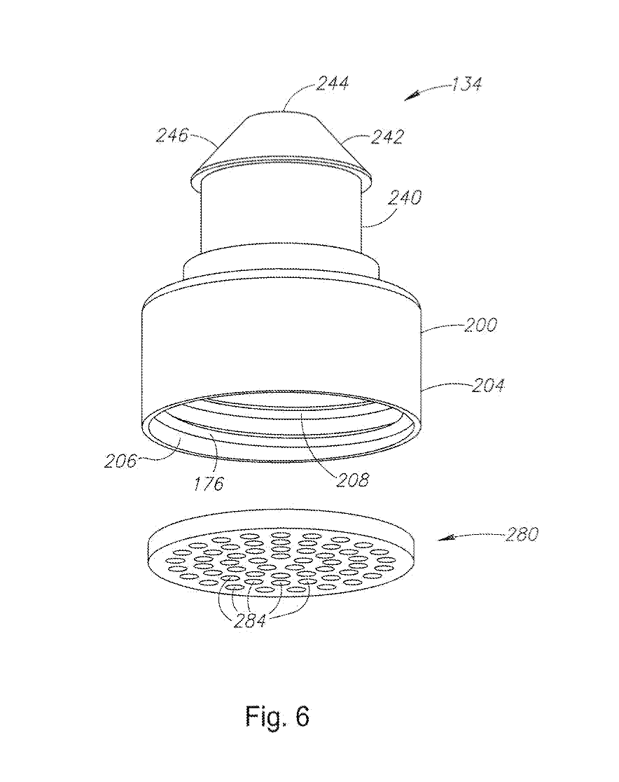

Referring to FIG. 6, the closure 100 (see FIG. 1) may include an optional filter 280. The filter 280 may be receivable inside the open lower portion 206 of the cap connector portion 200 of the cap portion 134 and may optionally snap inside the hollow interior portion 208. Turning to FIG. 4, the hollow interior portion 208 may include at least one optional filter retainer projection 282 extending inwardly from the inside surface of the lower outer sidewall 204. The projection(s) 282 may be located between the inside threads 176 and the internal stop portion 220. The filter 280 may be pressed upwardly into the hollow interior portion 208 and forced past the projection(s) 282 to removably secure it in place. Once located between the projection(s) 282 and the internal stop portion 220, the filter 280 is prevented from exiting the hollow interior portion 208 through the open lower portion 206 by the projection(s) 282.

Returning to FIG. 6, the filter 280 may include perforations 284. Alternatively, the filter 280 may be implemented as a charcoal filter, a foam or ceramic filter, a combination of these, and the like. Further, the filter 280 may be implemented as a screen or other type of filtering or screening device. For example, the filter 280 may be implemented as a charcoal water filter, a water distiller, a ceramic water filter, a reverse osmosis filter, an ultraviolet water filter, and the like. The filter 280 filters one or more components from the liquid 120 (see FIG. 3) after it leave the supplement retention area 138 (see FIG. 3). By way of a non-limiting example, the filter 280 may be coated with a coating (not shown) configured to filter one or more components from the liquid 120 (see FIG. 3) after it leave the supplement retention area 138 (see FIG. 3).

The shape and size of the first connector portion 146 may be determined at least in part by the type of container used to implement the container 102. Further, the shape and size of the second connector portion 160 may be determined at least in part by the type of cap or cap portion used. Therefore, the relative sizes of the first and second connector portions 146 and 160 depicted in the figures are for illustrative purposes and not are intended to be limiting. Further, while the supplement housing portion 130 and the cap portion 134 have been described as being separate components removably couplable together, through application of ordinary skill in the art to the present disclosure, embodiments may be constructed in which the supplement housing portion and the cap portion are a single or unitary component and such embodiments are within the scope of the present teachings.

Turning to FIG. 3, the supplement housing portion 130 may be included in a kit (not shown) along with at least one of the cap portion 134, the container 102, at least one of the dissolvable supplement bodies 140A, 140B, and 140C, the filter 260, the filter 270 (see FIG. 5), and the filter 280 (see FIG. 6). By way of a non-limiting example, a kit may include the supplement housing portion 130 and the cap portion 134.

By way of another non-limiting example, a kit may include the supplement housing portion 130 and the dissolvable supplement bodies 140A, 140B, and 140C. Such a kit may be used with any commercially available bottle and cap portion sold together (or separately), including prepackaged commercially available bottled beverages, such as bottled water. The dissolvable supplement bodies 140A, 140B, and 140C may be preassembled inside the supplement retention area 138 or may be separate from the supplement housing portion 130.

The closure 100 may be assembled by coupling the first connector portion 146 of the supplement housing portion 130 to the threaded neck portion 110 of the container 102. In embodiments including the filter 260, the filter 260 may be snapped inside the hollow interior portion 152 (see FIG. 4) of the first connector portion before it is coupled to the threaded neck portion 110 of the container 102. In embodiments including the filter 270, the outside threads 272 of the filter 270 may be threaded into the inside threads 154 of the first connector portion before it is coupled to the threaded neck portion 110 of the container 102.

Before or after the first connector portion is coupled to the threaded neck portion 110 of the container 102, the dissolvable supplement bodies 140A, 140B, and 140C are inserted inside the supplement retention area 138. Then, the cap connector portion 200 is coupled to the second connector portion 160 of the supplement housing portion 130. In embodiments including the filter 280, the filter 280 may be snapped inside the hollow interior portion 208 (see FIG. 6) of the cap connector portion 200 before it is coupled to the second connector portion 160 of the supplement housing portion 130.

After the closure 100 is assembled and coupled to the threaded neck portion 110 of the container 102, the liquid 120 may be poured from the container 102 (by tipping or inverting the container) through the closure 100 and past the dissolvable supplement bodies 140A, 140B, and 140C therein to produce the supplemented liquid. Once outside the closure 100, the supplemented liquid may be consumed by a user.

Different dissolvable supplement bodies may be inserted into the supplement retention area 138 by uncoupling the cap connector portion 200 from the second connector portion 160 of the supplement housing portion 130 and inserting different dissolvable supplement bodies into the supplement retention area 138. Further, liquid (e.g., water) may be added to the container 102 by uncoupling the first connector portion 146 of the supplement housing portion 130 from the threaded neck portion 110 of the container 102 and pouring liquid into the container 102 through the outlet 124.

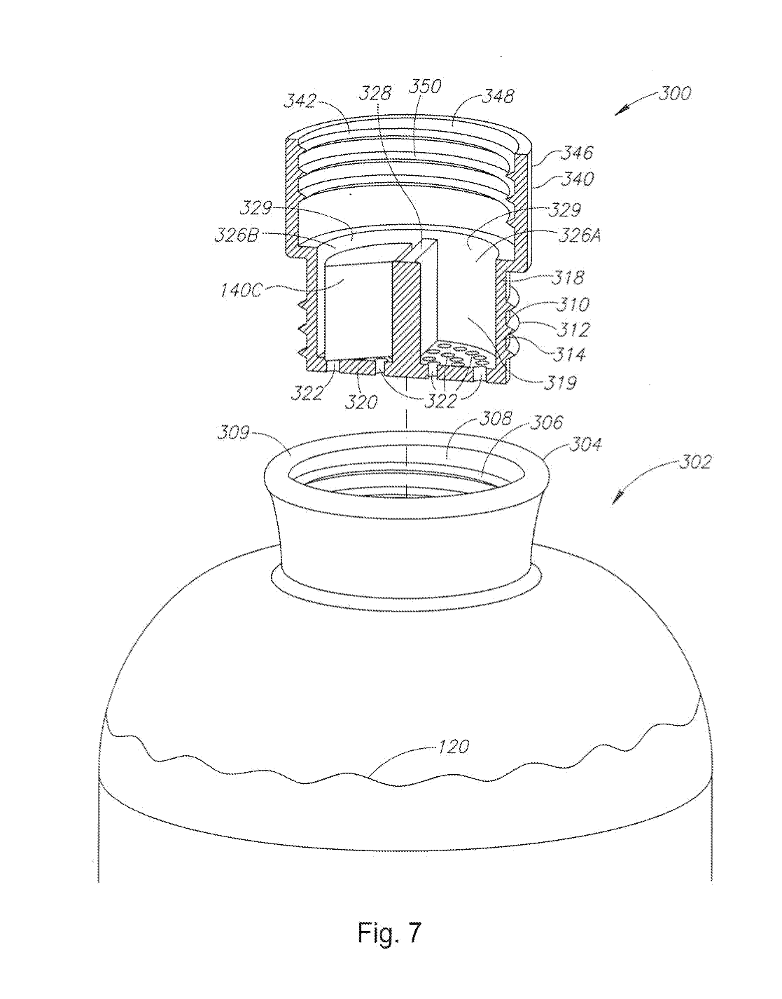

An alternate embodiment of the supplement housing portion 130 is illustrated in FIG. 7. FIG. 7 illustrates a supplement housing portion 300 configured for use with a bottle 302 having a threaded neck portion 304 with inside threads 306 disposed therein. The bottle 302 is illustrated housing the liquid 120. An outlet 308 is formed in an open distal portion 309 of the threaded neck portion 304.

By way of a non-limiting example, the bottle 302 may be implemented as a conventional SIGG bottle or container. A desirable feature of SIGG bottles is that they use the same diameter threaded neck portion (or head) and have the same inside threads disposed inside the threaded neck portion, which results in interchangeability of caps between different SIGG bottles.

The supplement housing portion 300 includes a first connector portion 310 having outside threads 312 configured to threadedly engage the inside threads 306 of the threaded neck portion 304 of the bottle 302. The first connector portion 310 is formed in a lower portion 314 of an outer sidewall 318, which defines a hollow interior portion 319. The hollow interior portion 319 is terminated along the lower portion 314 of the outer sidewall 318 by a perforated supplement support platform 320 substantially similar to the perforated supplement support platform 180 (described above and illustrated in FIG. 4). The perforated supplement support platform 320 has perforations 322 formed therein.

The lower portion 314 of the outer sidewall 318 is configured to be inserted inside the outlet 308 formed in the threaded neck portion 304 of the bottle 302 to position the perforated supplement support platform 320 inside the threaded neck portion 304 of the bottle 302. Once so inserted, the liquid 120 inside the bottle 302 may to be poured from the bottle 302 through the outlet 308 into the supplement housing portion 300 through the perforations 322 in the perforated supplement support platform 320.

The supplement housing portion 300 includes a supplement retention area 324 adjacent the perforated supplement support platform 320 that is substantially similar to the supplement retention area 138 (illustrated in FIG. 4 and described above). In the embodiment illustrated, the supplement retention area 324 is located at least partially inside the hollow interior portion 319 of the first connector portion 310.

Like the supplement retention area 138 (see FIG. 4), the supplement retention area 324 may optionally be divided into a plurality of supplement chambers (e.g., supplement chambers 326A, and 326B) by one or more dividing walls (e.g., dividing wall 328). For example, the supplement housing portion 300 may include three supplement chambers substantially similar to the supplement chambers 190A, 190B, and 190C (see FIG. 3) separated by three dividing walls substantially similar to the dividing walls 192A, 192B, and 192C (see FIG. 3).

Each of the supplement chambers (e.g., supplement chambers 326A, and 326B) have an open top portion 329 configured to receive a dissolvable supplement body (e.g., the dissolvable supplement body 140C) inside the supplement chamber. As the liquid 120 flows through the supplement chambers, the dissolvable supplement bodies are dissolved by the liquid and combine therewith to form a supplemented liquid, which flows out of the supplement chambers through their open top portions 329.

The supplement housing portion 300 includes a second connector portion 340 having inside threads 342 configured to threadedly engage outside threads (not shown) of a cap portion (not shown). The second connector portion 340 is formed in an upper portion 346 of the outer sidewall 318, which defines an open upper portion 348 in communication with a hollow interior portion 350.

The cap portion (not shown) may be implemented as any cap receivable inside the hollow interior portion 350 through the open upper portion 348 and having outside threads configured to engage the inside threads 342 of the second connector portion 340. In embodiments in which the bottle 302 is implemented as a SIGG bottle, the cap portion may be implemented as any cap suitable for use with a SIGG bottle. For example, suitable caps couplable to the second connector portion 340 may be obtained from MySIGG.com of Stamford, Conn., which operates a website at www.mysigg.com. Non-limiting examples of suitable caps available from MySIGG.com include the SIGG Sports Top, Active Bottle Top, and Kids Bottle Top. Thus, the cap portion may be selectively couplable to either the second connector portion 340 or the threaded neck portion 304 of the bottle 302. However, this is not a requirement.

The supplemented liquid flows out of the supplement chambers (e.g., supplement chambers 326A, and 326B) through their open top portions 329 and into the cap portion (not shown). The cap portion includes an exit aperture (not shown) through which the supplemented liquid may exit the cap portion to be consumed by the user. A lower portion of the cap portion (not shown) functions as the internal stop portion 220 (see FIG. 4), retaining the dissolvable supplement bodies 140A, 140B, and 140C (see FIG. 3) inside the supplement retention area 324 as the liquid 120 flows past and dissolves them.

Unlike prior art supplemented beverages (such as sports drinks, energy drinks, dietary drinks, wellness drinks, etc.) which include a premixed selection of supplements, the supplemented liquid created using the supplement housing portions 130 and 300 may be created from a custom selected set of dissolvable supplement bodies 140A, 140B, and 140C selected by the user. In other words, the supplement housing portions 130 and 300 allow the user to customize their selection of dissolvable supplement bodies 140A, 140B, and 140C to create a custom supplemented liquid for their individual use. The dissolvable supplement bodies 140A, 140B, and 140C may be selected based on a user's individual needs or desires. The dissolvable supplement bodies 140A, 140B, and 140C may be configured to have the same or complementary flavors so that any supplement body may be used with any other supplement body without producing an undesirable flavor combination.

The dry solid dissolvable supplement bodies 140A, 140B, and 140C reside in the supplement retention area 138 (or the supplement retention area 324), which are spaced apart from the liquid 120 stored inside the container 102 (or the bottle 302). Thus, when the user is not pouring the liquid 120 from the container 102 (or the bottle 302), the dissolvable supplement bodies remain dry, which helps the supplements retain their effectiveness. As is appreciated by those of ordinary skill in the art, vitamins and other healthful ingredients deteriorate when dissolved or immersed in water or other liquids. In particular, Vitamin C loses about 80% of its potency after only thirty days of exposure to water. Thus, many nutrients, including vitamins lose their effectiveness if stored in water or other liquids for too long. The supplement housing portions 130 and 300 help avoid a loss of effectiveness of such nutrients by spacing the dissolvable supplement bodies 140A, 140B, and 140C from the liquid 120 when they are not being dissolved to create the supplemented liquid. Further, because the supplemented liquid may be consumed immediately after it is created, the vitamins, nutrients, and other healthful ingredients do not have time to deteriorate as a result of their exposure to the liquid 120 such as during shipment or storage, or while being carried during periods of non-use by a user.

Because the dissolvable supplement bodies 140A, 140B, and 140C each dissolve at a dissolve rate as the liquid 120 flows past them, the amount of supplement introduced into the liquid 120 is controlled or limited by this dissolve rate. Thus, the user consumes a dosage of the supplements based upon the amount of liquid consumed. Further, a total amount of supplemented liquid created is based upon the amount of liquid 120 poured from the container 102 through the supplement housing portions 130 and 300. If a user chooses to drink less than the entire amount of liquid 120 stored in the container 102, only a corresponding portion of the dissolvable supplement bodies 140A, 140B, and 140C will be dissolved by the liquid 120 as it is poured from the container 102. In this manner, the supplement housing portions 130 and 300 provide a uniform dosage of supplements in the liquid 120, no matter how much is consumed by the user and when it is consumed.

Many supplements (including vitamins) are toxic if consumed in too large of a quantity (i.e., an overdose). By sizing each of the supplement chambers 190A, 190B, and 190C to accept only a single dissolvable supplement body 140A, 140B, and 140C, respectively, the supplement housing portions 130 and 300 may help prevent a user from consuming too much of any one supplement. In contrast, simply dissolving supplements in a liquid or swallowing supplement tablets or capsules can results in an inadvertent overdose.

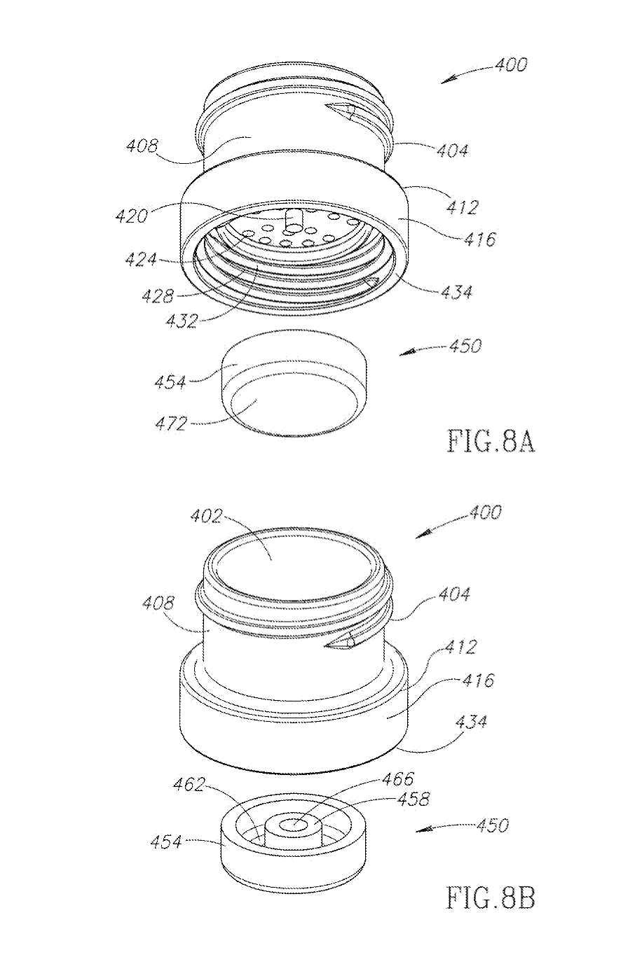

Turning to FIGS. 8A and 8B, a supplement housing portion 400 and a filter 450 are shown. The supplement housing portion 400 shares several aspects with the supplement housing portion 130 (see FIG. 3), and may be included as part of the closure 100 (see FIG. 3) and used with the cap portion 134 to house one or more dissolvable supplement bodies (e.g., dissolvable supplement bodies 140A, 140B, and 140C). The supplement housing portion 400 has an outer sidewall 434 that may be generally symmetric about a vertical central axis (not shown). For example, the outer sidewall 434 may have a generally cylindrical shape with a circular cross-sectional shape. In the embodiment illustrated, the central axis is substantially parallel to a liquid flow direction and the supplement housing portion 400 is elongated along the central axis. However, these are not requirements. Further, the outer sidewall 434 need not be symmetric about the central axis. For example, implementations in which the outer sidewall 434 defines a supplement housing portion having a curved or bent shape are within the scope of the present disclosure.

The supplement housing portion 400 has a first connector portion 412 couplable to the outlet 124 of the container 102 (see FIG. 3) or any other suitable container (e.g., generic plastic water bottles, various sizes of stainless steel or aluminum bottles, Nalgene® type BPA bottles, hands free hydration system units, or the like). The first connector portion 412 is formed in a lower portion 416 of the outer sidewall 434, which defines an open lower portion 432 configured to allow the threaded neck portion 110 (see FIG. 3) of the container 102 (see FIG. 3) to pass therethrough into the open lower portion 432 of the first connector portion 412. In this manner, the outlet 124 (see FIG. 3) of the container 102 (see FIG. 3) is received inside the open lower portion 432 to allow the liquid 120 (see FIG. 3) to be poured from the container through the outlet into the supplement housing portion 400.

In the embodiment illustrated, the first connector portion 412 includes inside threads 428 disposed on the inside of the lower portion 416 of the outer sidewall 434 configured to threadably engage the outside threads 112 (illustrated in FIG. 3) of the threaded neck portion 110 (see FIG. 3) of the container 102 (see FIG. 3) to removably secure the supplement housing portion 400 to the container in a fluid tight manner.

The outer sidewall 434 of the supplement housing portion 400 has an upper portion comprising a second connector portion 408 couplable to the cap portion 134 (see FIG. 3). In the embodiment illustrated, the second connector portion 408 has outside threads 404 disposed on the outside of the second connector portion of the outer sidewall 434 configured to threadably engage inside threads 176 disposed inside the cap portion 134 to removably secure the cap portions to the supplement housing portion 400 (see FIG. 4). The upper end of the second connector portion 408 has an upper open portion 402.

When the cap portion 134 is coupled to the second connector portion 408 of the supplement housing portion 400, a supplement retention area is defined between the cap portion 134, the inside of the outer sidewall 412, the upper open portion 402, and a perforated supplement support platform 424 (see FIG. 8A) located between the second connector portion 408 and the open lower portion 432. The perforated supplement support platform 424 may be transverse to the flow direction of the liquid 120 (see FIG. 3). In the embodiment illustrated, the perforated supplement support platform 424 is located between the first and second connector portions 412 and 408. However, this is not a requirement and embodiments in which the perforated supplement support platform 424 is located within either of the first and second connector portions 412 and 408 are within the scope of the present teachings.

In the embodiment shown in FIGS. 8A and 8B, the supplement housing portion 400 has a filter 450 removably attached thereto. The filter 450 may be receivable inside the open lower portion 432 of the first connector portion 412 of the supplement housing portion 400. The filter 450 includes an outer wall 454, an inner base portion 462 and an outer base portion 472. As shown in FIG. 8B, the filter 450 may also include an inner wall 458 extending upward from the inner base portion 462 and having an opening 466 sized to receive a filter retainer projection 420 that extends downward from the center of the perforated supplement support platform 424. The filter 450 may be pressed upwardly into the open lower portion 432 and forced upwardly onto the projection 420 to removably secure the filter 450 in place in juxtaposition and engagement with the perforated supplement support platform 424, such that the liquid 120 passes through the filter 450 when consumed by a user. The coupling between the projection 420 and the inner wall 458 of the filter 450 may generally be referred to as a “press fit.” Once coupled to the projection 420, the filter 450 is prevented from exiting the open lower portion 432 during normal usage by a user drinking liquid 120 that has passed through the filter 450. As can be appreciated, the size and shape of the projection 420 and the opening 466 formed by the inner wall 458 may any suitable size and shape such that a removable press fit is formed.

The filter 450 may include perforations (not shown). Alternatively, the filter 450 may be implemented as a charcoal filter, a foam or ceramic filter, a combination of these, and the like. In one embodiment, the filter 450 is formed from a porous material available from Porex Corporation, Fairburn, Ga. In this embodiment, the filter 450 may be a formed from a single sintered plastic molded piece. The material forming the filter 450 may be selected to have a specific porosity to allow for particulate filtration and an adequate flow of liquid through the filter for ease of liquid delivery to a user. Further the material forming the filter 450 may be selected to have a carbon filler in an amount designed to aid in the filtration of chlorine, ammonia, Bisphenol A (BPA), or other components that may be present in a liquid. By way of a non-limiting example, the filter 450 may also be coated with a coating (not shown) configured to filter one or more components from the liquid 120 (see FIG. 3). The filter 450 may also prevent any small pieces of one of the dissolvable supplement bodies 140A, 140B, and 140C (see FIG. 3) from passing through one of the perforations of the perforated supplement support platform 424 and entering the container 102.

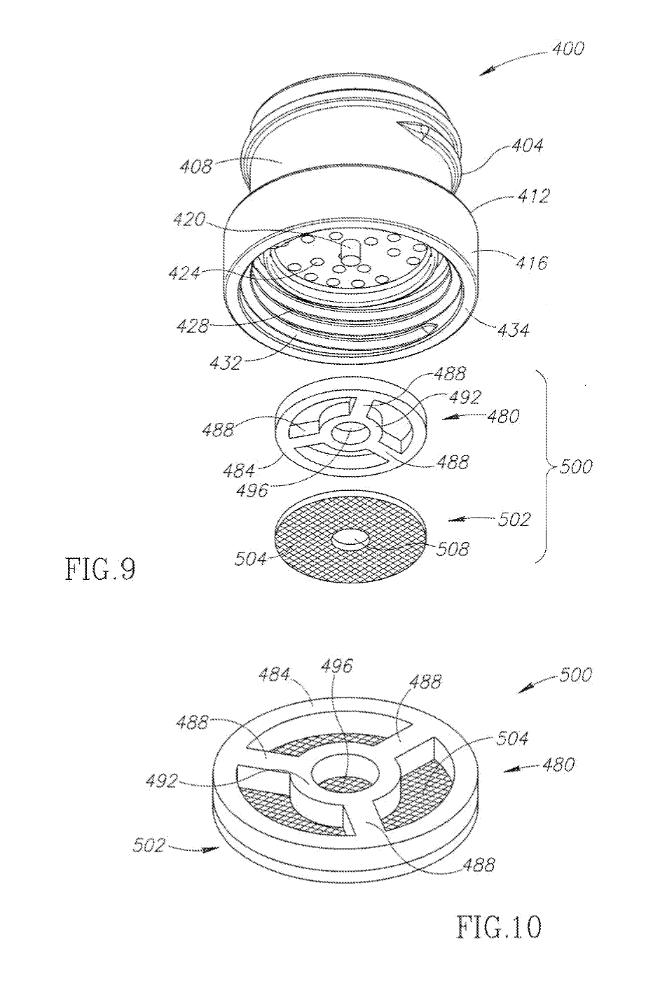

FIG. 9 illustrates an unassembled exploded view of another embodiment of a filter 500 that may be used with the supplement housing portion 400 shown in FIGS. 8A and 8B. For illustration purposes, the filter 500 is also shown in FIG. 10 in its assembled form. The filter 500 includes a filter screen 502 and a frame 480 coupled together. For example, the filter 502 may be implemented as a charcoal water filter, a water distiller, a ceramic water filter, a reverse osmosis filter, an ultraviolet water filter, and the like. By way of a non-limiting example, the filter screen 502 may be coated with a coating (not shown) configured to filter one or more components from the liquid 120 (see FIG. 3). In one embodiment, the filter screen 502 is formed from a carbon-impregnated polypropylene-woven mesh material. The filter screen 502 includes a porous portion 504 and an opening 508.

In one embodiment, the frame 480 is formed from a polypropylene plastic material, but other materials may also be used. The frame 480 may be attached to the filter screen 502 by means of an ultrasonic welding process or other suitable process operative to couple the filter screen and the frame together. The frame 480 includes an outer frame portion 484 and an inner frame portion 492 coupled together by three spoke portions 488. The inner frame portion 492 of the frame 480 defines an opening 496 having a shape and size configured such that the assembled filter 500 may be removably pressed on to the projection 420 of the supplement housing portion 400. Similar to the filter 450 described above, the assembled filter 500 (see FIG. 10) may be receivable inside the open lower portion 432 of the supplement housing portion 400 in juxtaposition and engagement with the perforated supplement support platform 424. The filter 500 may be pressed upwardly into the open lower portion 432 and forced onto the projection 420 to removably secure it in place (e.g., a press fit), such that the liquid 120 (see FIG. 3) passes through the filter 500 during use. Once secured to the projection 420, the filter 500 is prevented from exiting the open lower portion 432 of the supplement housing portion 400 by the projection 420 during normal usage by a user drinking liquid 120 that has passed through the filter 500.

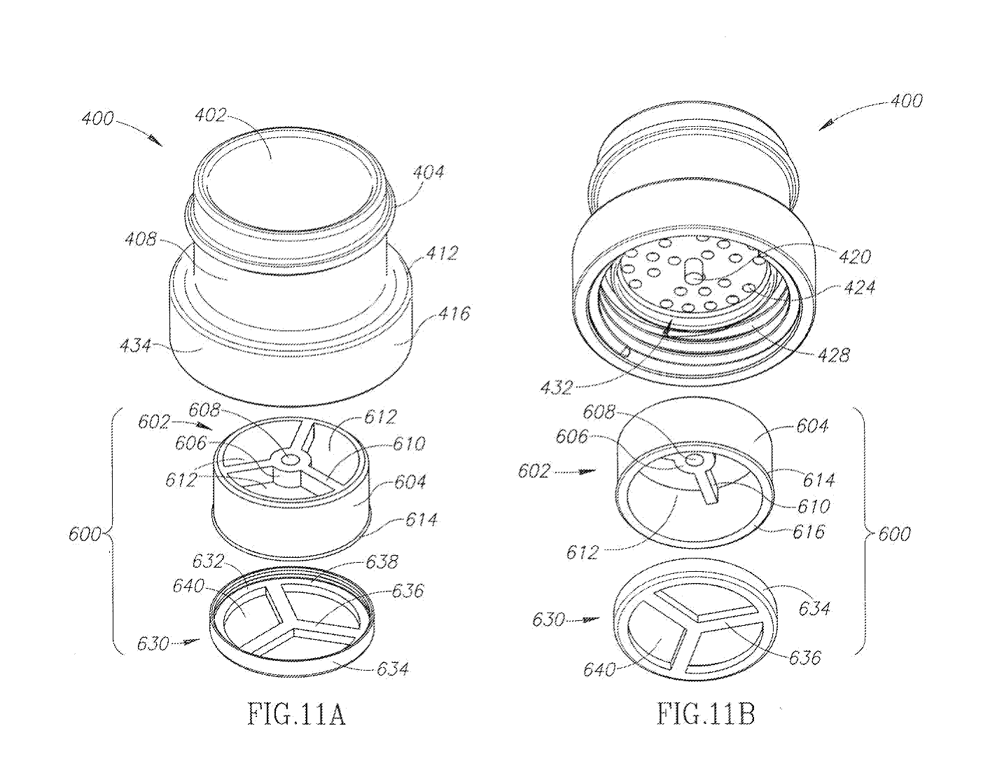

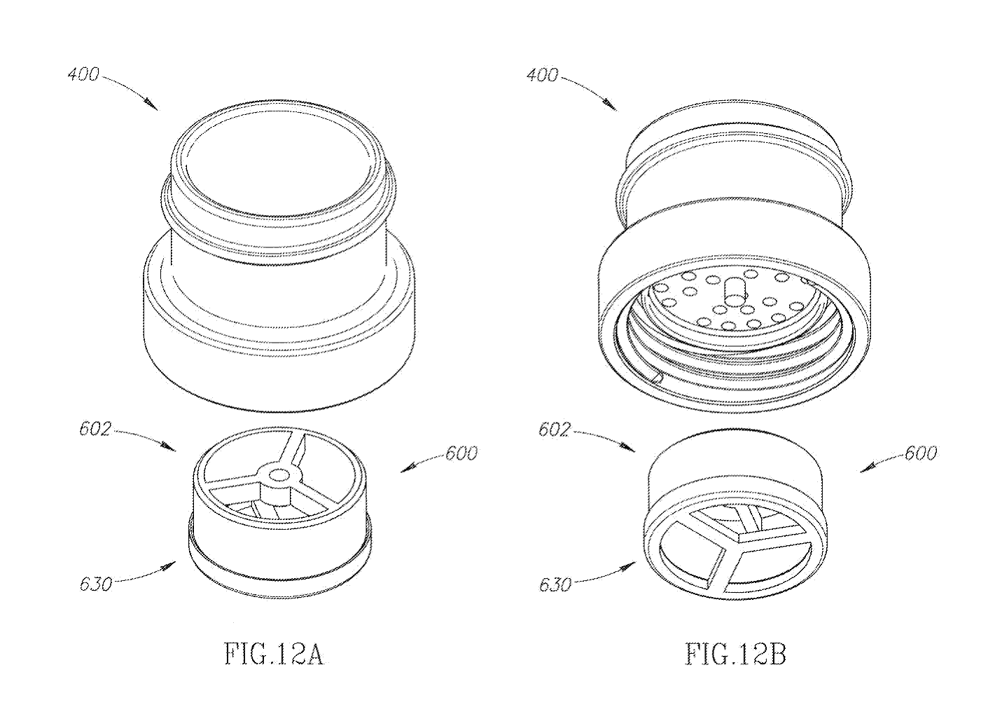

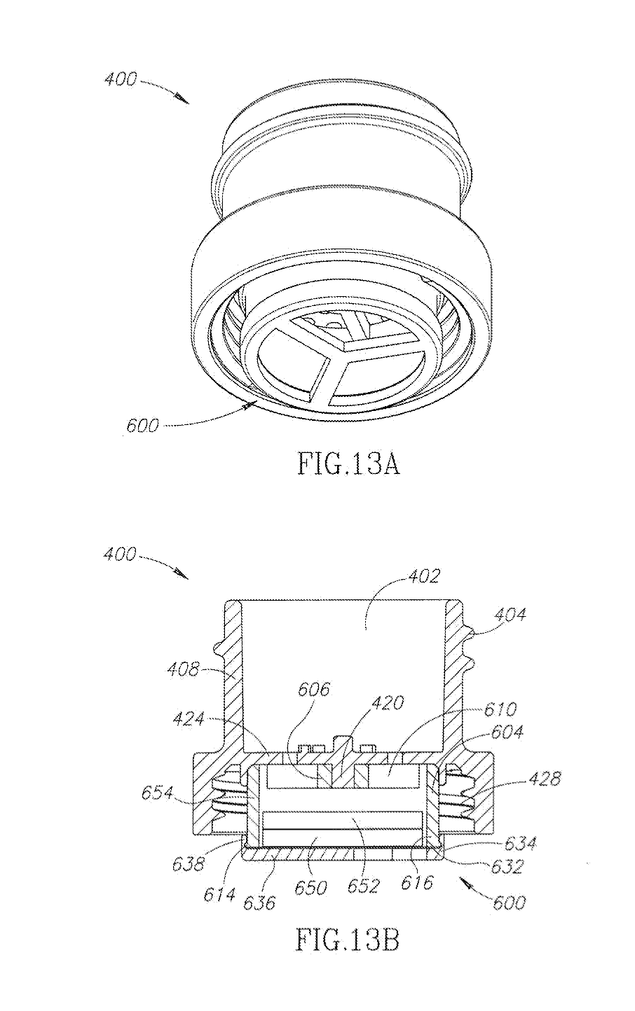

FIGS. 11A, 11B, 12A, 12B, 13A, and 13B illustrate various views of another embodiment of a filter housing 600 that may be used with the supplement housing portion 400 also shown in FIGS. 8A, 8B, and 9. Specifically, FIGS. 11A and 11B are top and bottom exploded perspective views respectively of the filter housing 600 and supplement housing portion 400. FIGS. 12A and 12B are top and bottom perspective views respectively of the filter housing 600 and supplement housing portion 400, wherein the filter housing is in an assembled configuration and is unattached to the supplement housing portion. FIG. 13A is a bottom perspective view of the assembled filter housing 600 removably attached to the supplement housing portion 400. FIG. 13B is a side cross-sectional view of the assembled filter housing 600 attached to the supplement housing portion 400, wherein disposable filters 650, 652 are positioned within an internal space or filter chamber 654 of the filter housing.

As may best be viewed in FIGS. 11A and 11B, the filter housing 600 comprises a body portion 602 and a lid portion 630 that are configured to be removably or fixedly coupled together (see FIGS. 12A and 12B). The body portion 602 includes a circumferential outer sidewall 604 that terminates with widened bottom surface 616 (see FIG. 11B), thereby defining a circumferential lip 614. The body portion 602 also includes a central inner portion 606 coupled to the outer sidewall 604 by three spoke portions 610 defining openings 612 which allow a liquid to pass through the body portion 602. As can be seen in FIGS. 11A and 11B, the inner portion 606 and the spoke portions 610 may be substantially aligned with the upper-most portion of the sidewall 604, but are spaced apart from the bottom surface 616. That is, the vertical height of the inner portion 606 and the spoke portions 610 is less than the height of the sidewall 604. As discussed below, this feature allows the filter housing 600 to include the filter chamber 654 configured for removable receipt of one or more disposable filters 650, 652. The inner portion 606 of the body portion 602 is configured to define an opening 608 having a shape and size such that the assembled filter housing 600 may be removably pressed onto the filter retainer projection 420 that extends downward from the center of the perforated supplement support platform 424 of the supplement housing portion 400 (see FIG. 11B).

The lid portion 630 of the filter housing 600 includes a circumferential base portion 632 having an outer sidewall 634 extending upward therefrom. The outer sidewall 634 includes a groove 638 sized to removably receive the circumferential lip 614 of the body portion 602 when the body portion and the lid portion 630 are coupled together, thereby forming a “snap fit” (see FIG. 13B). The lid portion 630 further includes spoke portions 636 defining openings 640 that allow liquid to pass therethrough.

In operation, a user may selectively attach the lid portion 630 of the filter housing 600 to the body portion 602 by utilizing the “snap fit” interface between them. In some embodiments, the lid portion 630 and the body portion 602 may be permanently attached during manufacturing. When the lid portion 630 is separated from the body portion 602, the user may place one or more filters (e.g., the filters 650 and 652 shown in FIG. 13B) on the base portion 632 and spoke portions 636 of the lid portion. The user may then snap the lid portion 630 onto the body portion 602 to form the assembled filter housing 600 with the filters 650, 652 retained within the filter chamber 654. As shown in FIG. 13B, when the filter housing 600 is in the assembled condition, the filters 650 and 652 occupy the filter chamber 654 bounded on the top by the inner portion 606 and spoke portions 610 of the body portion 602, bounded on the bottom by the base portion 632 and the spoke portions 636 of the lid portion 630, and bounded on the sides by the inner surface of the sidewall portion 604. Thus, the filter chamber 654 has a substantially cylindrical shape and allows for removable receipt of one or more disc-shaped filters. In some embodiments, the filter chamber 654 has a height of about 0.25 inches to 0.5 inches, and a diameter of about 0.5 inches to 0.75 inches, but other suitable dimensions are contemplated. As can be appreciated, filters may be designed and shape to correspond to the particular dimensions of the filter chamber.

Similar to the filters 450 and 500 described above, the filter housing 600 may be selectively receivable inside the open lower portion 432 of the supplement housing portion 400 in juxtaposition and engagement with the perforated supplement support platform 424 (see FIGS. 13A and 13B). The filter housing 600 may be pressed upwardly into the open lower portion 432 and forced onto the projection 420 to removably secure it in place (e.g., a press or snap fit), such that the liquid 120 (see FIG. 3) passes through the filter housing during use. Once secured to the projection 420, the filter housing 600 is prevented from exiting the open lower portion 432 of the supplement housing portion 400 by the projection during normal usage by a user drinking liquid 120 that has passed through the filter housing. Advantageously, the filter housing 600 may be easily removed from the supplement housing portion 400 simply by pulling the two components apart, and the filter chamber 654 may be easily opened simply by pulling the body portion 602 and the lid portion 630 apart.

By providing a filter housing including the user accessible filter chamber 654, a variety of different filter media may be used. For example, filters may include multiple layers of filtration media each configured for a specific type of filtration. These layers may be physically separated from each other or attached together (e.g., by laminating multiple filter layers together). In one embodiment, the disposable filters are made from activated carbon cloth (ACC) made from 100% activated carbon. ACC has a large surface area (e.g., 1000-2000 m²/g) due to its high degree of micro-porosity. This, combined with the strong electrostatic forces developed within the cloth, enables the cloth to be highly efficient at adsorbing vapors and/or other contaminants. Further, to make the cloth more sensitive to adsorption of particular molecules, the cloth may be impregnated with one or more chemical treatments. For example, the cloth may be impregnated with silver due to its antimicrobial and antiseptic properties. In one embodiment, the disposable filters are comprised of multiple, silver impregnated, ACC layers.

Since users are able to easily change the filters in the filter chamber 654, users may select a particular filter or filters dependent on a desired quality. For example, users in different countries may wish to select filters particularly suited to filter contaminants known to be in their specific region. Accordingly, various filters may be manufactured having characteristics designed for particular applications.

In view of the fact that the filter chamber 654 may have a height of approximately 0.25 inches to 0.5 inches or more, filters having a similar thickness may be used and the filters may comprise multiple layers of filter material. The ability to use relatively thick filters permits a relatively large “residency rate,” which may increase the amount of contaminants that may be removed from a liquid while not substantially impacting the flow rate. Further, the use of relatively thick filters may permit each filter to have a relatively long useful life. For example, in one embodiment, a multi-layered filter having a thickness of about 0.25 inches may be rated for up to three gallons, or five uses per day, for up to one week.

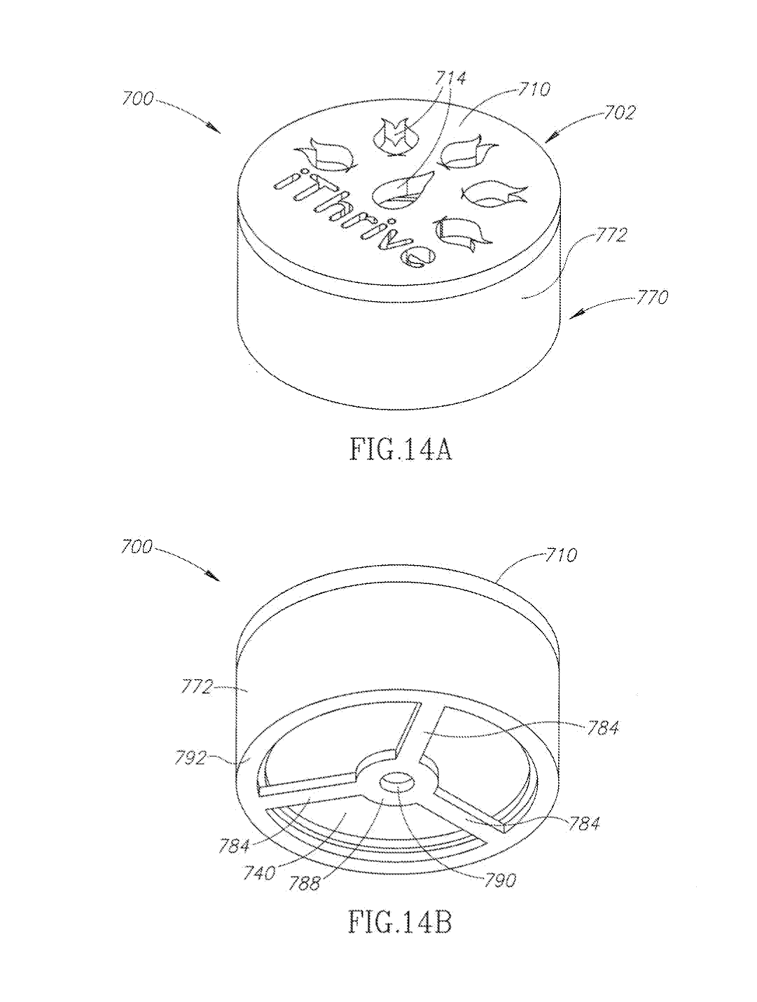

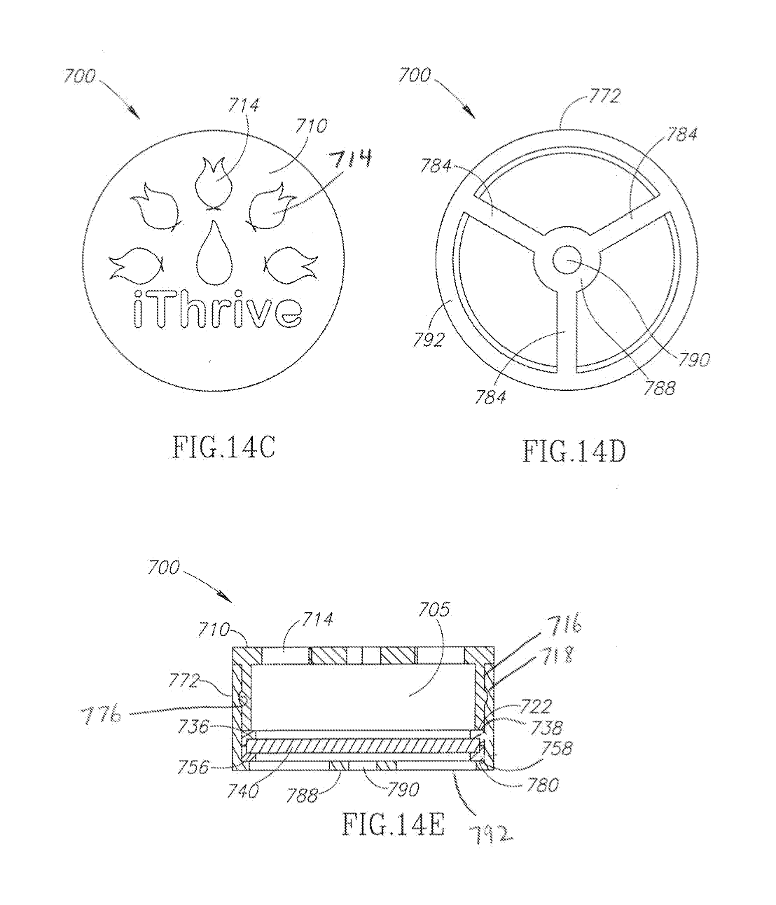

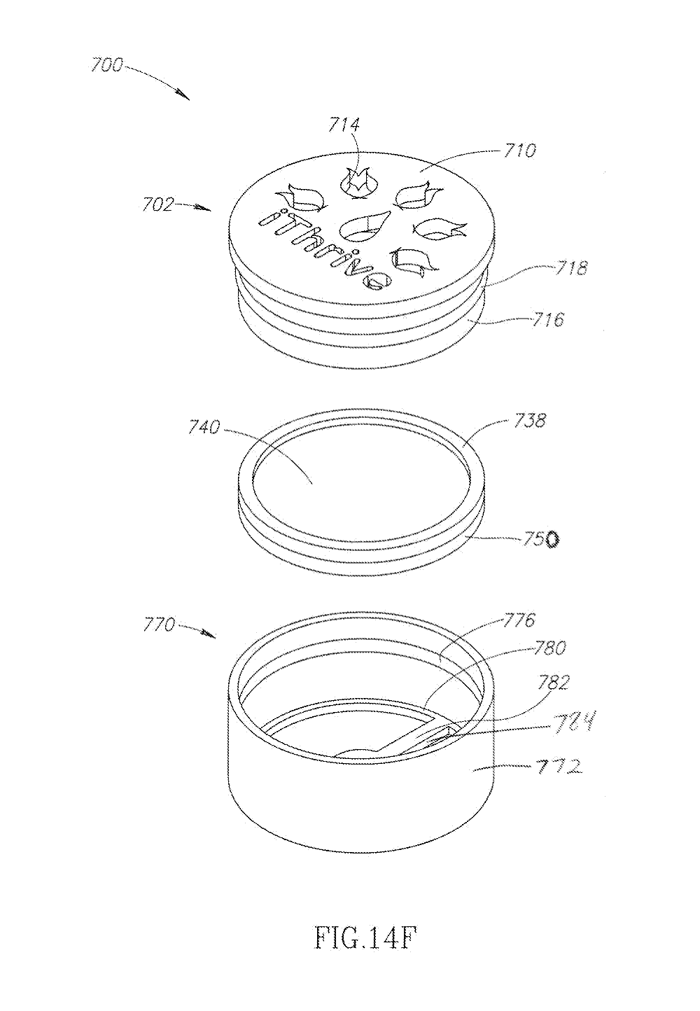

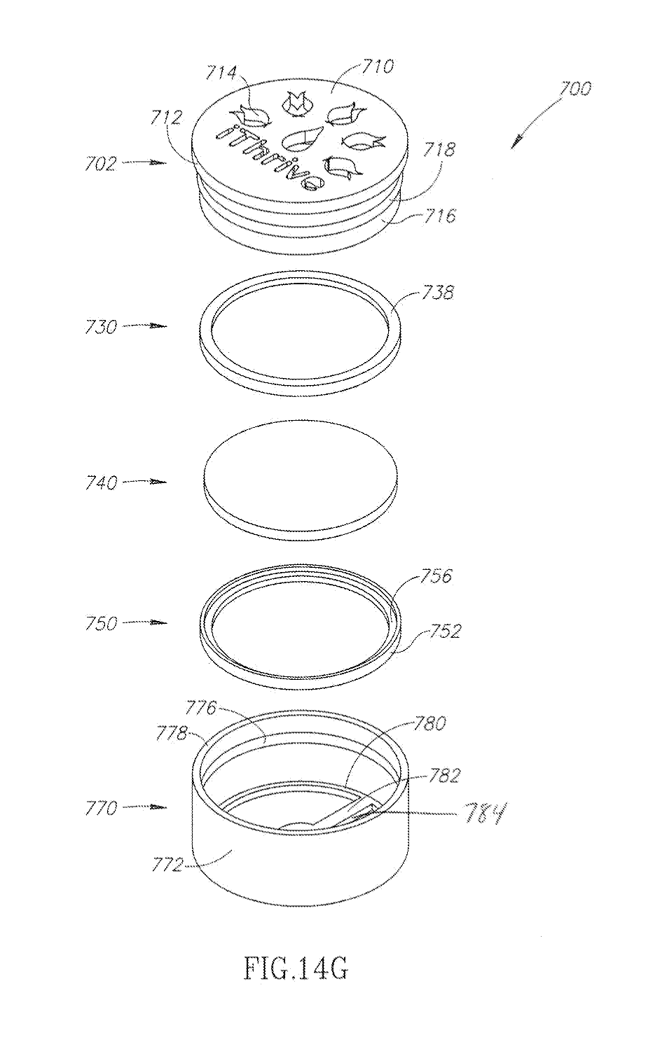

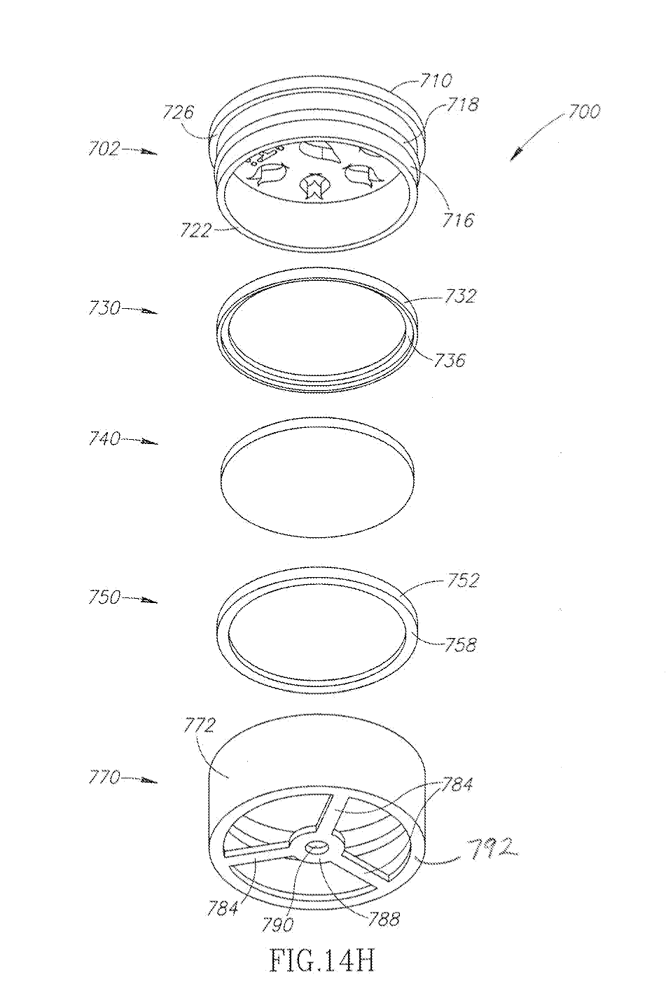

FIGS. 14A-14H illustrate various views of another embodiment of a filter housing or assembly 700 that may be used with the supplement housing portion 400 shown in FIGS. 8A and 8B. As shown in FIG. 14F, the filter assembly 700 includes a lid portion 702, a body portion 770, and a filter screen 740 clamped between a top clamp ring 730 and a bottom clamp ring 750. Similar to embodiments described above, the filter screen 740 may be implemented as a charcoal water filter, a water distiller, a ceramic water filter, a reverse osmosis filter, an ultraviolet water filter, a carbon-impregnated polypropylene-woven mesh material, and the like.

As shown best in FIGS. 14E, 14G, and 14H, the bottom clamp ring 750 includes a circumferential sidewall 752, a circumferential inner surface 756 positioned proximate the interior surface the sidewall, and a bottom surface 758. These components of the bottom clamp ring 750 together define a bottom frame or platform configured to receive the filter screen 740. Similarly, the top clamp ring 730 includes a circumferential sidewall 732, a circumferential inner surface 736, and a top surface 738 that together define a top frame for receiving the filter screen 740. As shown in FIGS. 14E and 14F, the top clamp ring 730 and the bottom clamp ring 750 may be brought together to form a frame that surrounds the edge of the filter screen 740. The top clamp ring 730 and the bottom clamp ring 750 may be attached to each other and to the filter screen 740 by means of an ultrasonic welding process or other suitable process operative to couple the filter screen and the clamp rings together.

The body portion 770 includes a cylindrical sidewall 772 that terminates in a lower cylindrical portion 792 (see FIGS. 14B and 14E) that has an inner diameter that is slightly smaller than the inner diameter of the sidewall 772, thereby forming a circumferential shelf 780. The lower cylindrical portion 792 is coupled to an inner frame portion 788 by three spoke portions 784, each having a top service 782. The inner frame portion 788 defines an opening 790 having a shape and size configured such that the assembled filter assembly 700 may be removably pressed on to the projection 420 of the supplement housing portion 400. Similar to the filter 450 described above, the assembled filter assembly 700 (see FIGS. 14A and 14B) may be receivable inside the open lower portion 432 of the supplement housing portion 400 in juxtaposition and engagement with the perforated supplement support platform 424. The filter assembly 700 may be pressed upwardly into the open lower portion 432 and forced onto the projection 420 to removably secure it in place (e.g., a press fit), such that the liquid 120 (see FIG. 3) passes through the filter assembly 700 during use. Once secured to the projection 420, the filter assembly 700 is prevented from exiting the open lower portion 432 of the supplement housing portion 400 by the projection 420 during normal usage by a user drinking liquid 120 that has passed through the filter assembly 700.

The lid portion 702 of the filter housing 700 includes a downwardly extending circumferential portion comprising a sidewall 716. The sidewall 716 includes a circumferential protrusion 718 on its outer surface sized to be removably or fixedly received in an interior circumferential groove 776 (see FIGS. 14E and 14F) of the sidewall 772 of the body portion 770 when the lid portion 702 is pressed into the body portion 770, thereby forming a “snap fit.” The lid portion 702 further includes a top portion 710 defining openings 714 that allow liquid to pass therethrough. The top portion 710 has a diameter that is larger than the sidewall 716 of the lid portion 702 and has substantially the same diameter as the sidewall 772 of the body portion 770, such that a perimeter portion 712 of the top portion 710 extends laterally outward beyond the sidewall 716 and has a bottom surface 726 that contacts a top surface 778 of the body portion 770 when the filter assembly 700 is in an assembled condition.

In operation, a user may selectively attach the lid portion 702 of the filter assembly 700 to the body portion 770 by utilizing the “snap fit” interface between them. When the lid portion 702 is separated from the body portion 770, the user may place the filter screen 740 (and the clamp rings 730 and 750 coupled thereto) on the inner shelf 780 and top surfaces 782 of the spoke portions 784 of the body portion. The user may then snap the lid portion 702 onto the body portion 770 to form the assembled filter assembly 700 with the filter screen 740 retained within a filter chamber 705. As shown in FIG. 14E, when the filter assembly 700 is in the assembled condition, the bottom clamp ring 750 is bounded below by the top surface of the shelf 780 and top surfaces 782 of the spoke portions 782 of the body portion 770. The top clamp ring 730 is bounded above by a bottom surface 722 of the lid portion 702. The top clamp ring 730 and the bottom clamp ring 750 are bounded on the laterally outward sides by the inner surface of the sidewall portion 772 of the body portion 770. Thus, the filter assembly 700 allows for removable receipt of one or more filters. In other embodiments, the lid portion 702 and the body portion 770 may be permanently coupled together (e.g., via sonic welding).

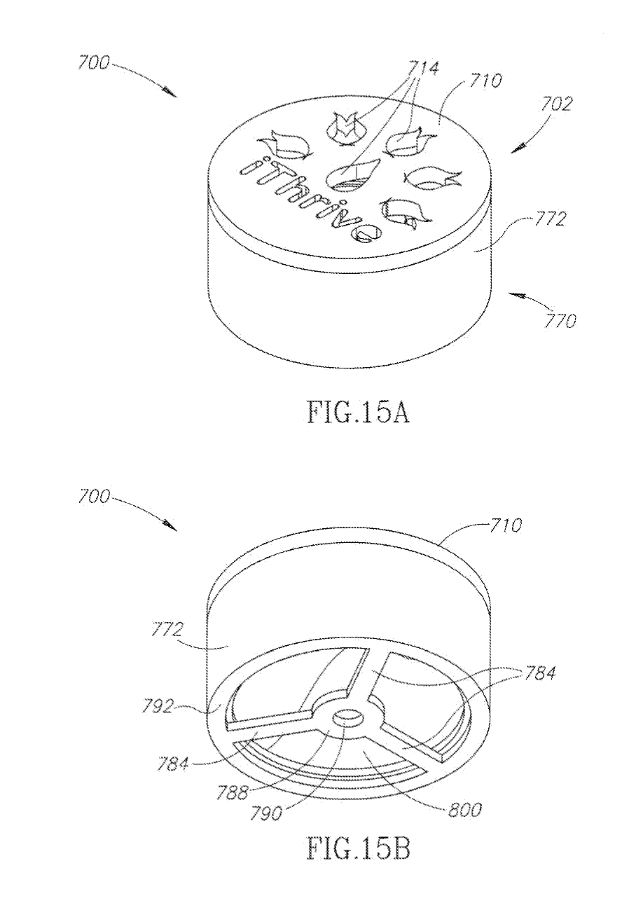

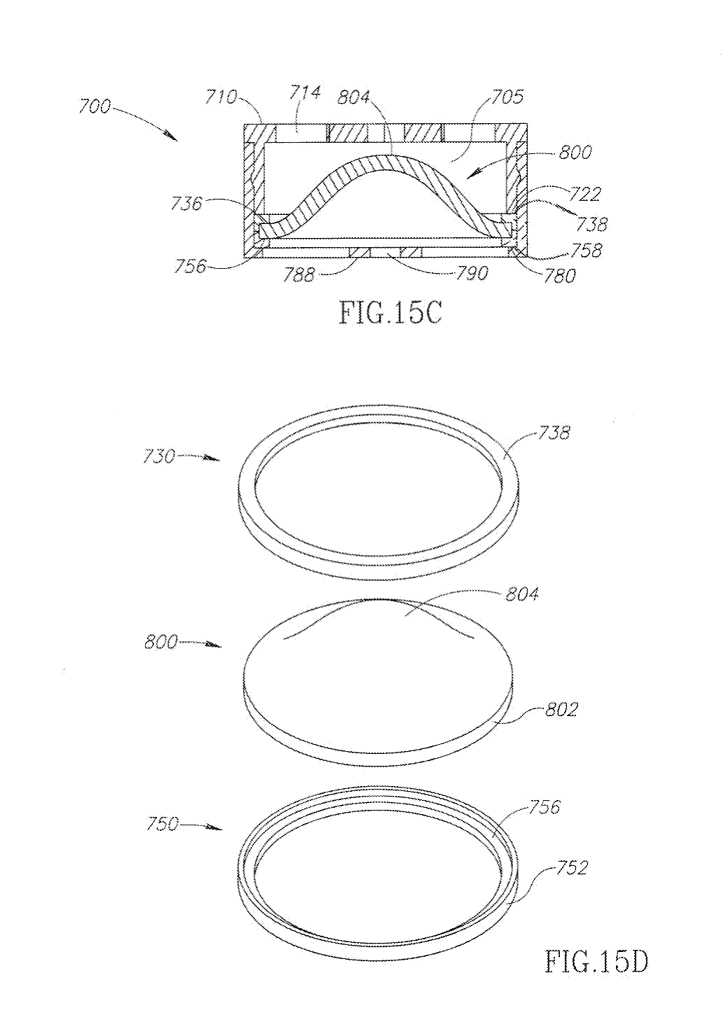

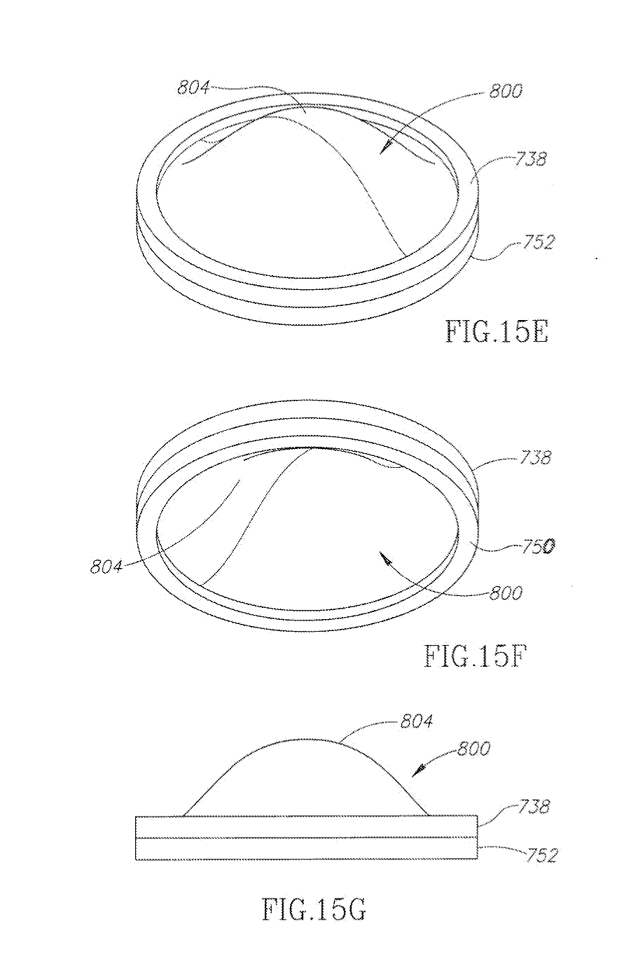

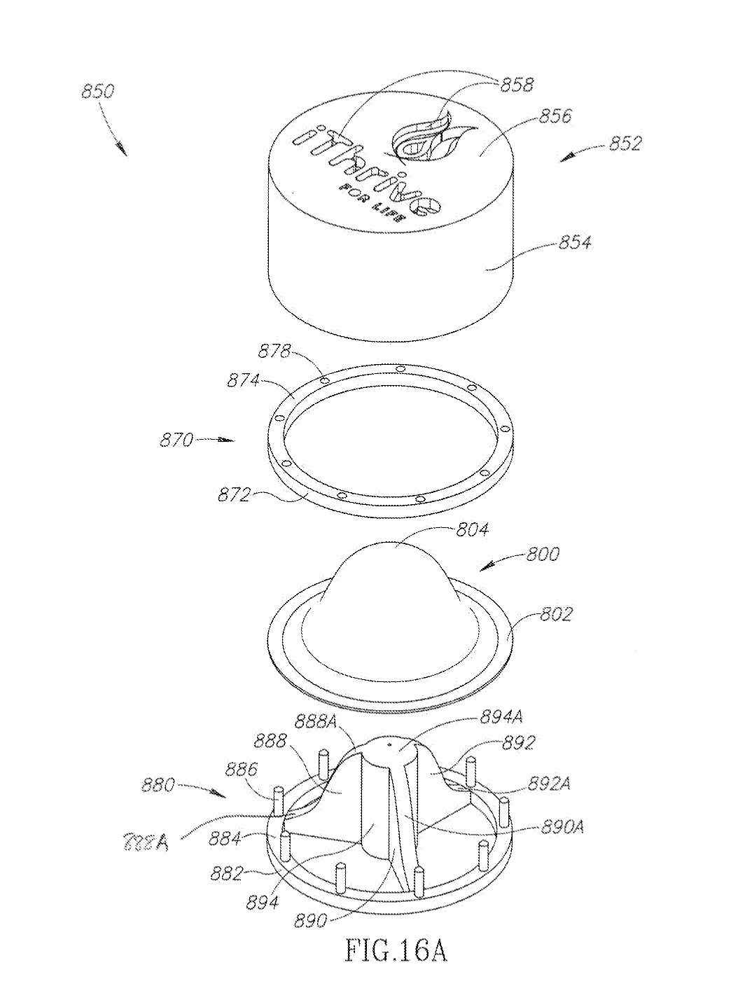

FIGS. 15A-15G illustrate various views of another embodiment of the filter housing or assembly 700 that may be used with the supplement housing portion 400 shown in FIGS. 8A and 8B. The embodiment shown in FIGS. 15A-15G has many similarities to the embodiment shown in FIGS. 14A-14H. Accordingly, only the components in the embodiment shown in FIGS. 15A-15G that are different from the previously described embodiment are discussed below.

As shown in FIG. 15D, a domed filter screen 800 is provided in this embodiment. The filter screen 800 comprises a dome shaped portion 804 and a perimeter edge portion 802. Similar to the filter screen 740 described above, the filter screen 800 may be framed or “clamped” by the top clamp ring 730 and the bottom clamp ring 750. The top clamp ring 730 and the bottom clamp ring 750 may be attached to each other and to the filter screen 800 by means of an ultrasonic welding process or other suitable process operative to couple the filter screen and the clamp rings together.

In this embodiment, the domed filter screen 800 provides a substantially larger surface area than the flat filter screen 740 described above. This feature allows a higher flow rate of liquid through the filter screen 800 and may also improve the effectiveness and longevity of the filter screen. Further, although a dome shaped filter screen is shown and described herein, other non-planar shapes that provide an increased surface area relative to planar shaped filter screens may also be used. The filter screen 800 may be implemented as a charcoal water filter, a water distiller, a ceramic water filter, a reverse osmosis filter, an ultraviolet water filter, and the like. By way of a non-limiting example, the filter screen 800 may be coated with a coating (not shown) configured to filter one or more components from the liquid 120 (see FIG. 3). In one embodiment, the filter screen 800 is formed from a carbon-impregnated polypropylene-woven mesh material.

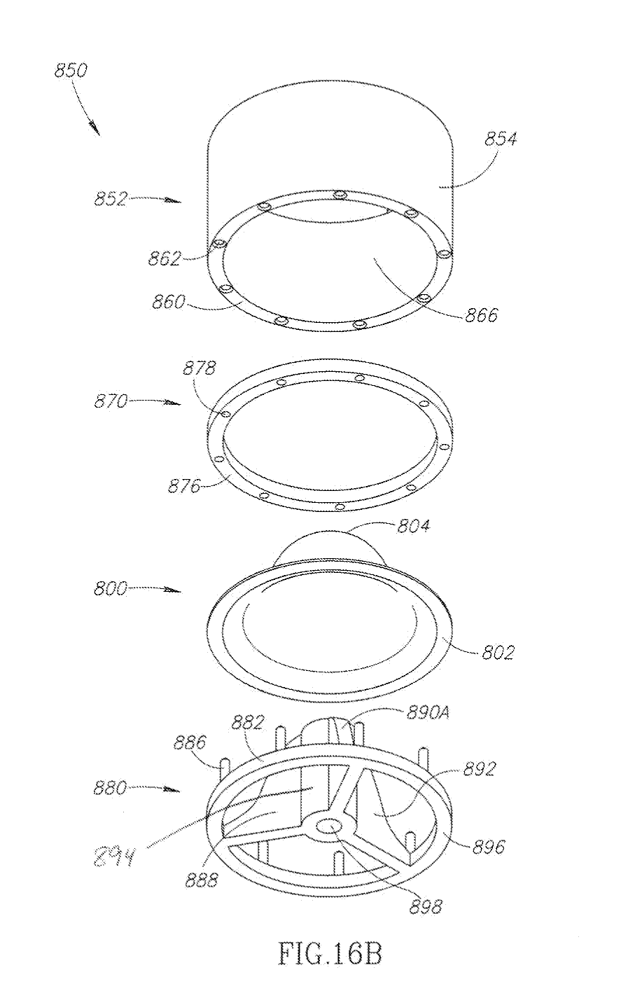

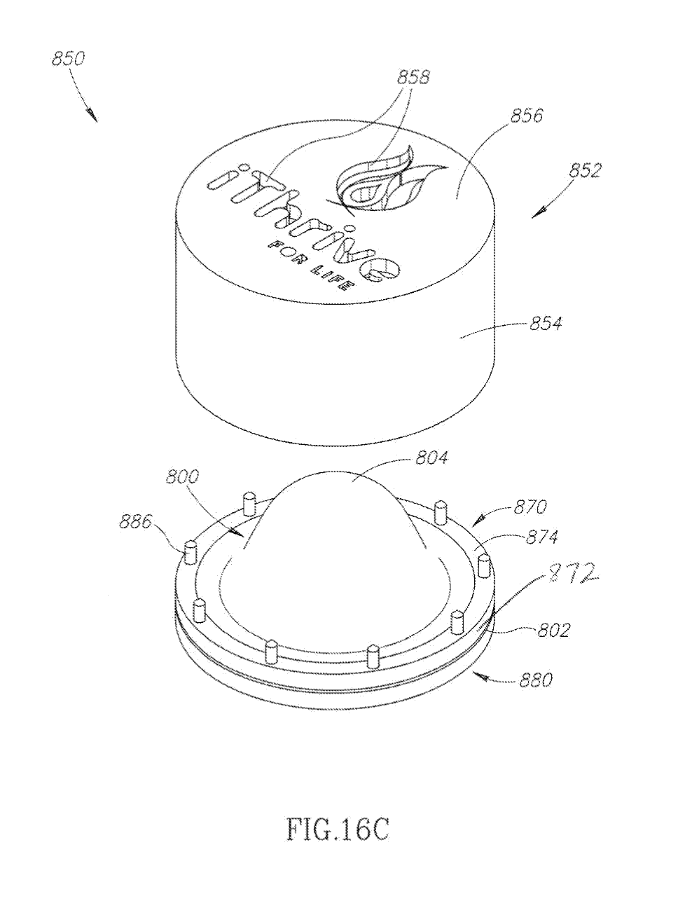

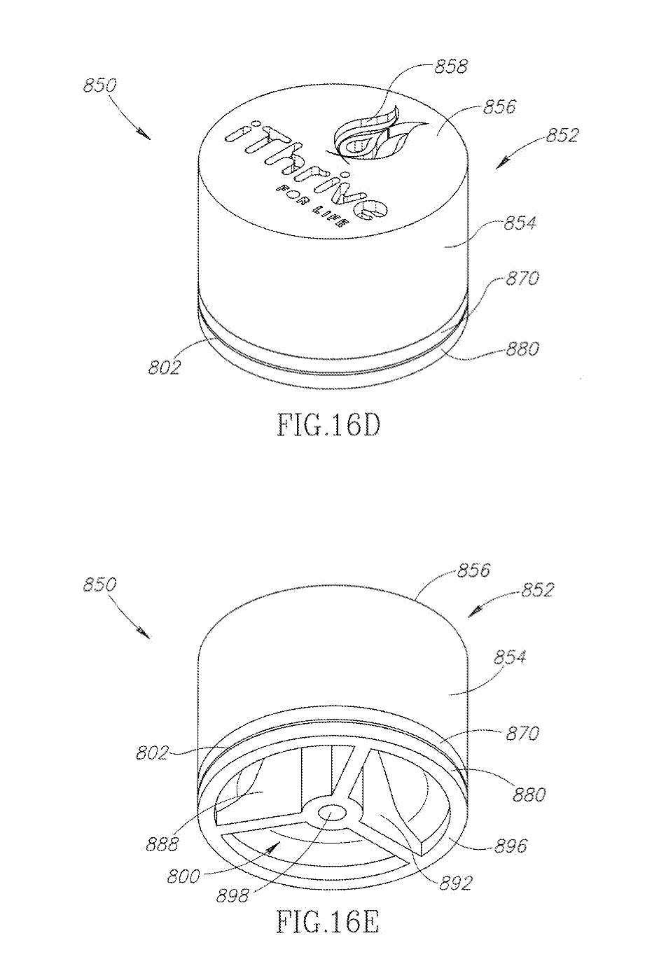

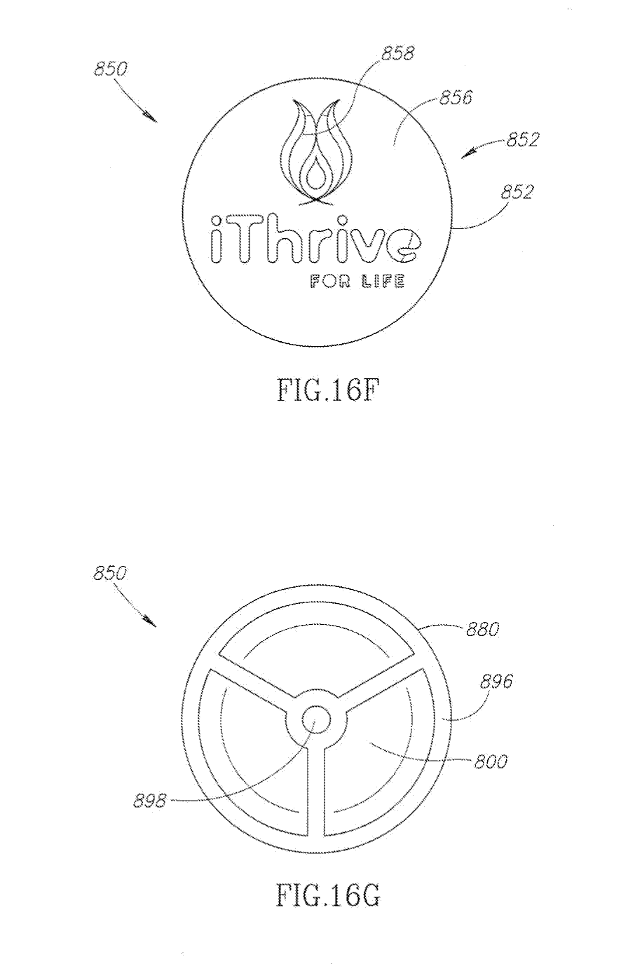

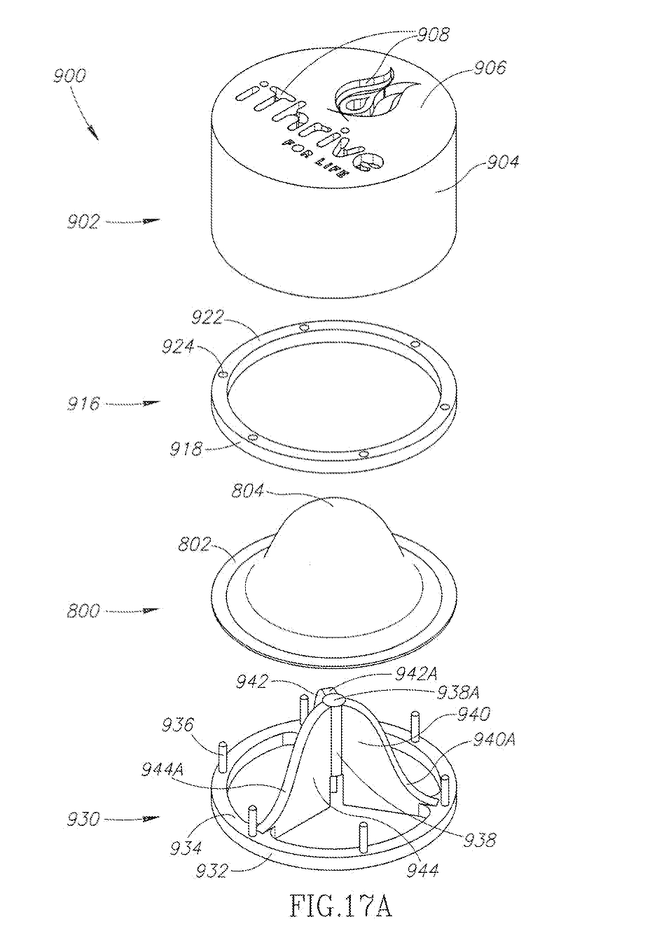

FIGS. 16A-16G illustrate various views of another embodiment of a filter housing or assembly 850 that may be used with the supplement housing portion 400 shown in FIGS. 8A and 8B. As shown in FIGS. 16A and 16B, the filter housing 850 includes a body portion 852, the domed filter screen 800 (discussed above), a top clamp ring 870, and a bottom clamp ring 880. The filter assembly 850 is shown in its fully assembled configuration in FIGS. 16D, 16E, 16F, and 16G.

The bottom clamp ring 880 comprises a circumferential base portion 882 having a top surface 884 and a bottom surface 896 (see FIG. 16B). The top surface 884 includes a plurality of spikes 886 extending upwardly therefrom. The base portion 882 is coupled to an inner portion 894 via three spoke portions 888, 890, and 892. As shown best in FIG. 16B, the inner portion 894 defines an aperture 898 that is sized to receive the projection 420 of the supplement housing portion 400, so that the filter assembly 850 may be used as described above in relation to other embodiments.

The inner portion 894 and the spoke portions 888, 890, and 892 are shaped such that their top surfaces 894A, 888A, 890A, and 892A, respectively, form a frame for supporting engagement with the domed filter screen 800 to maintain the filter screen's shape during use. As shown in FIG. 16C, the filter screen 800 may be pressed over the bottom clamp ring 880 such that the spikes 886 are punched through the outer perimeter edge portion 802 of the filter screen. As can be appreciated, the filter screen 800 is supported by (and its shape is maintained by) the inner portion 894 and the spoke portions 888, 890, and 892.

The top clamp ring 870 comprises a circumferential portion 872 having a plurality of apertures 878 that extend between a top surface 874 and a bottom surface 876 (see FIG. 16B). The apertures 878 are sized and positioned to correspond to the spikes 886 of the bottom clamp ring 880. Once the filter screen 800 is positioned on the bottom clamp ring 880, the top clamp ring 870 may be positioned over the spikes 886 and on top of the perimeter edge portion 802 of the filter screen 800 (see FIG. 16C).

The body portion 852 of the filter assembly 850 comprises a cylindrical sidewall 854 and a top portion 856 that together form an inner chamber 866 shaped to receive the domed filter screen 800 when in an assembled condition. The top portion 856 includes a plurality of openings 858 configured to permit liquid to pass therethrough. The sidewall 854 includes a plurality of apertures 862 (see FIG. 16B) extending upwardly therein from a bottom surface 860 of the sidewall. Similar to the plurality of apertures 878 of the top clamp ring 870, the apertures 862 are sized and positioned to correspond to the spikes 886 of the bottom clamp ring 880.

From the configuration of the filter assembly shown in FIG. 16C, the body portion 852 may be pressed onto the top clamp ring 870 such that the bottom surface 860 of the body portion contacts the top surface 874 of the top clamp ring. As can be appreciated, each of the spikes 886 of the bottom clamp ring 880 will be inserted into one of the apertures 862 of the body portion 852. The body portion 852, the top clamp ring 870, the filter screen 800, and the bottom clamp ring 880 may then be attached to each other by means of an ultrasonic welding process or other suitable process operative to couple the filter screen, the clamp rings, and body portion together. Once assembled, the filter assembly 850 may be removably coupled to the projection 420 of the supplement housing portion 400, so that the filter assembly may be used as described above.

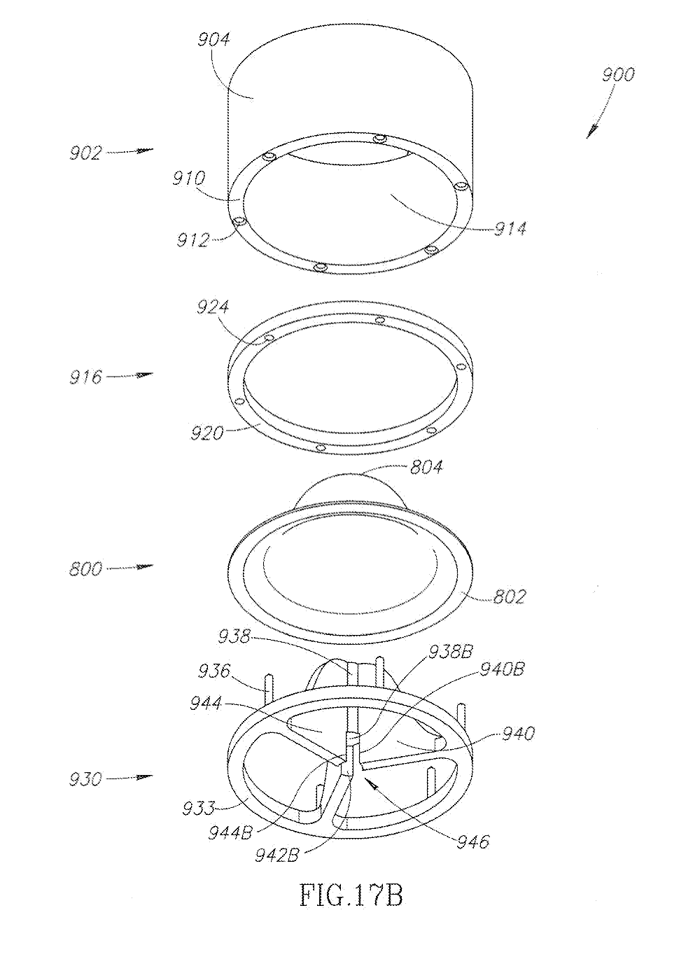

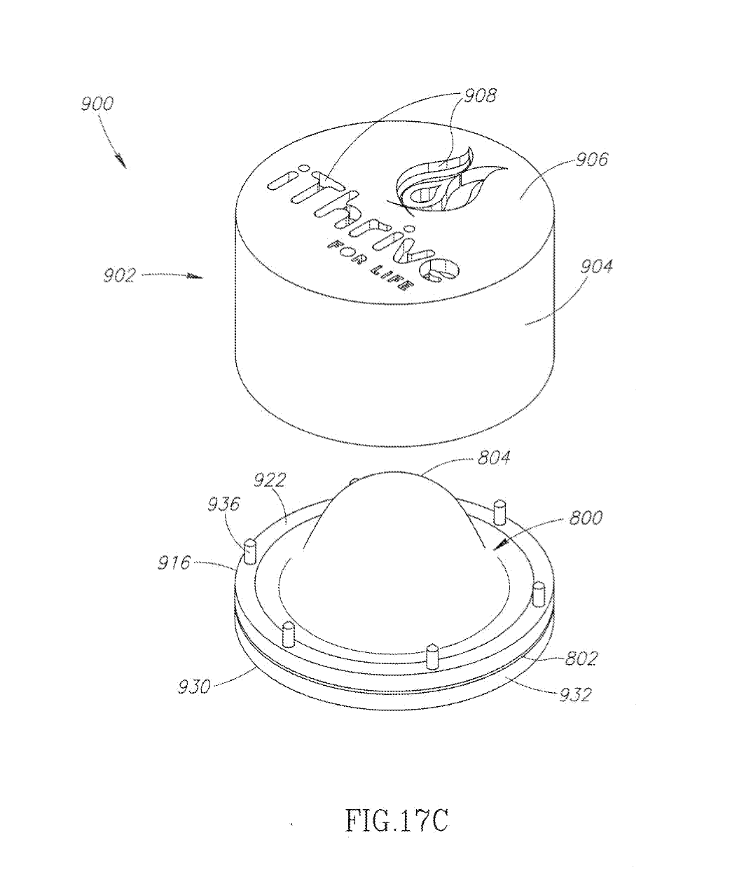

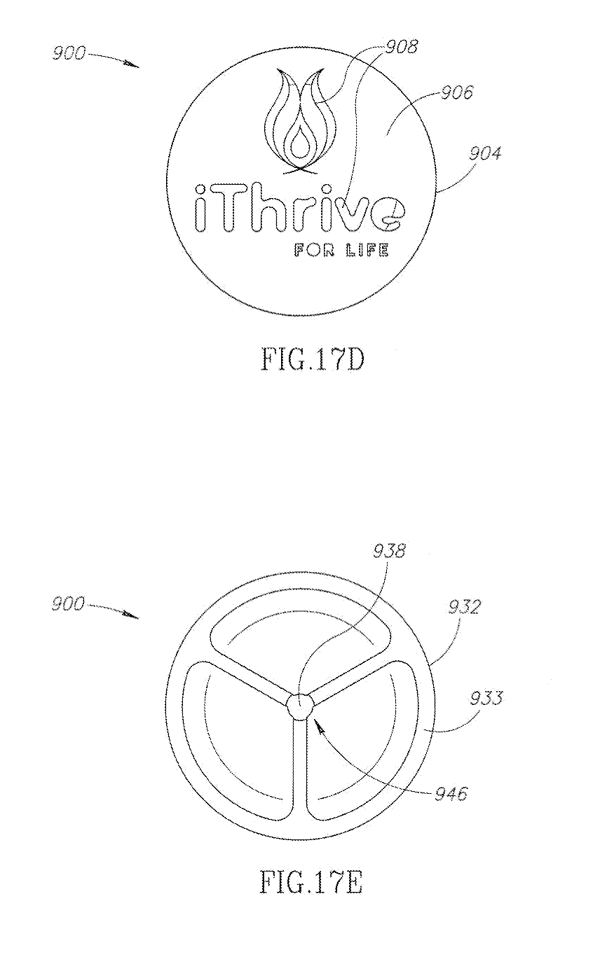

FIGS. 17A-E illustrate various views of another embodiment of a filter housing or assembly 900 that may be used with the supplement housing portion 400 shown in FIGS. 8A and 8B. The filter assembly 900 is similar to the filter assembly 850 shown in FIGS. 16A-16G in many respects. As shown in FIGS. 17A and 17B, the filter housing 900 includes a body portion 902, the domed filter screen 800, a top clamp ring 916, and a bottom clamp ring 930.

The bottom clamp ring 930 comprises a circumferential base portion 932 having a top surface 934 and a bottom surface 933 (see FIG. 17B). The top surface 934 includes a plurality of spikes 936 extending upwardly therefrom. The base portion 932 is coupled to an inner portion 938 via three spoke portions 940, 942, and 944. As shown best in FIG. 17B, lower portions 940B, 942B, 944B of the spoke portions 940, 942, and 944, respectively, and a bottom surface 938B of the inner portion 938 together define a void 946 that is sized to receive the projection 420 of the supplement housing portion 400, so that the filter assembly 900 may be used as described above in relation to other embodiments by coupling the filter assembly to the projection.

The inner portion 938 and the spoke portions 940, 942, and 944 are shaped such that their top surfaces 938A, 940A, 942A, and 944A, respectively, form a frame for supporting engagement with the domed filter screen 800 to maintain the filter screen's shape during use. As shown in FIG. 17C, the filter screen 800 may be pressed over the bottom clamp ring 930 such that the spikes 936 are punched through the perimeter edge portion 802 of the filter screen. As can be appreciated, the shape of the filter screen 800 is supported by the inner portion 938 and the spoke portions 940, 942, and 944.

The top clamp ring 916 comprises a circumferential portion 918 having a plurality of apertures 924 that extend between a top surface 922 and a bottom surface 920 (see FIG. 17B). The apertures 924 are sized and positioned to correspond to the spikes 936 of the bottom clamp ring 930. Once the filter screen 800 is positioned on the bottom clamp ring 930, the top clamp ring 916 may be positioned over the spikes 936 and onto the outer edge 802 of the filter screen 800 (see FIG. 17C).

The body portion 902 of the filter assembly 900 comprises a cylindrical sidewall 904 and a top portion 906 that together form an inner chamber 914 shaped to receive the domed filter screen 800 when in an assembled condition. The top portion 906 includes a plurality of openings 908 configured to permit liquid to pass therethrough. The sidewall 904 includes a plurality of apertures 912 (see FIG. 17B) extending upwardly therein from a bottom surface 910 of the sidewall. Similar to the plurality of apertures 924 of the top clamp ring 916, the apertures 912 are sized and positioned to correspond to the spikes 936 of the bottom clamp ring 930.

From the configuration of the filter assembly shown in FIG. 17C, the body portion 902 may be pressed onto the top clamp ring 916 such that the bottom surface 910 of the body portion contacts the top surface 922 of the top clamp ring. As can be appreciated, each of the spikes 936 of the bottom clamp ring 930 will be inserted into one of the apertures 912 of the body portion 902. The body portion 902, the top clamp ring 916, the filter screen 800, and the bottom clamp ring 930 may be attached to each other by means of an ultrasonic welding process or other suitable process operative to couple the filter screen, the clamp rings, and body portion together. Once assembled, the filter assembly 900 may be removably coupled to the projection 420 of the supplement housing portion 400, so that the filter assembly may be used as described above.

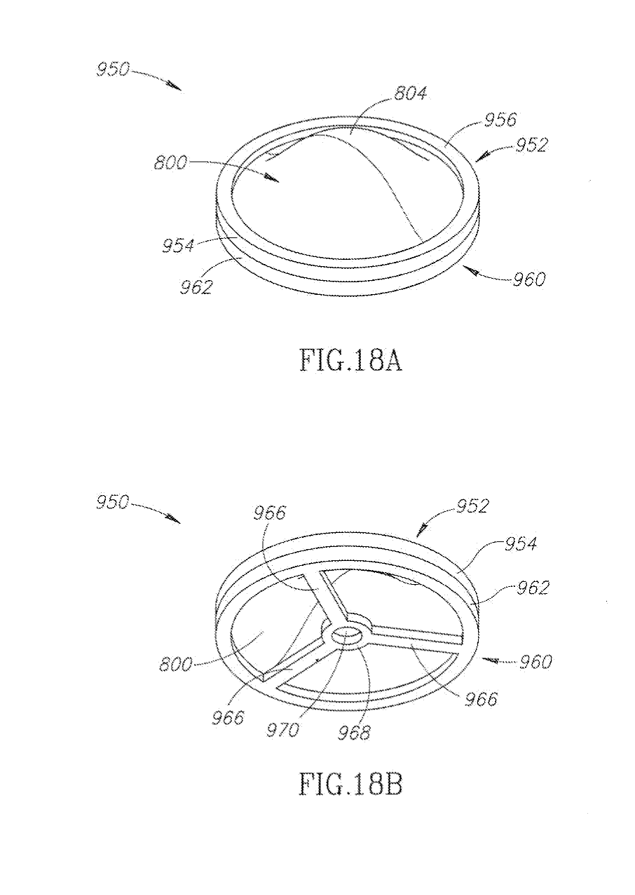

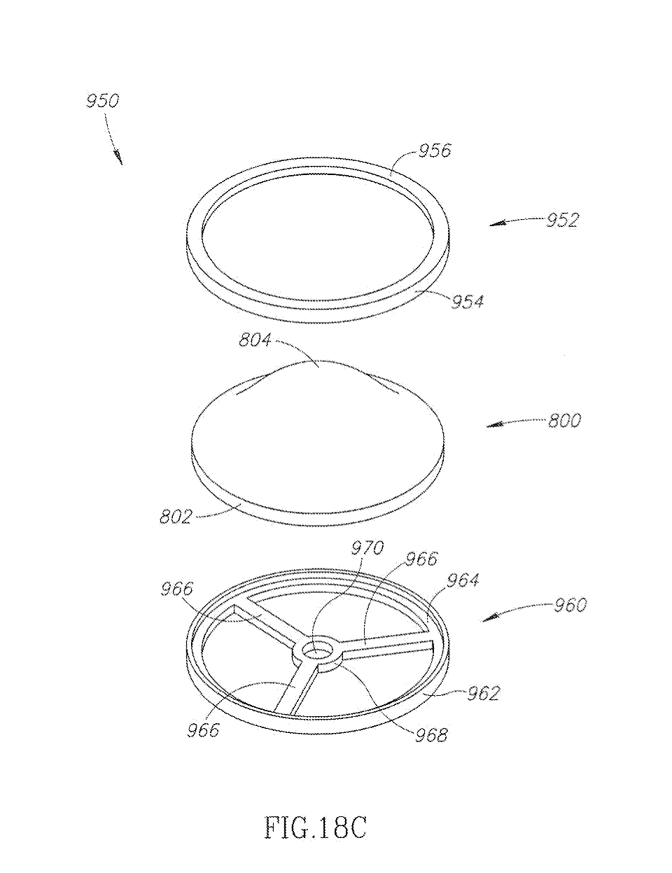

FIGS. 18A-18C illustrate various views of another embodiment of a filter assembly 950 that may be used with the supplement housing portion 400 shown in FIGS. 8A and 8B. As shown in FIG. 18C, the filter assembly 950 includes the domed filter screen 800, a top clamp ring 952, and a bottom clamp ring 960.

As shown best in FIG. 18C, the bottom clamp ring 960 includes a circumferential sidewall 962 and a circumferential upwardly facing surface 964 positioned inside the sidewall. The surface 964 is coupled to an inner frame portion 968 by three spoke portions 966. The inner frame portion 968 defines an opening 970 having a shape and size configured such that the assembled filter assembly 950 may be removably pressed on to the projection 420 of the supplement housing portion 400. Similar to embodiments described above, the bottom clamp ring 960 defines a bottom frame or platform configured to receive the filter screen 800. Similarly, the top clamp ring 952 includes a circumferential sidewall 954, a circumferential downward facing surface (not shown; see the surface 736 of the top clamp ring 730 shown in FIG. 14H), and a top surface 956 that together define a top frame for receiving the filter screen 800. As shown in FIGS. 18A and 18B, the top clamp ring 952 and the bottom clamp ring 960 may be brought together to form a frame that surrounds the edge 802 of the filter screen 800. The top clamp ring 952 and the bottom clamp ring 960 may be attached to each other and to the filter screen 800 by means of an ultrasonic welding process or other suitable process operative to couple the filter screen and the clamp rings together.

Similar to embodiments described above, the assembled filter assembly 950 may be receivable inside the open lower portion 432 of the supplement housing portion 400 in juxtaposition and engagement with the perforated supplement support platform 424. The filter assembly 950 may be pressed upwardly into the open lower portion 432 and forced onto the projection 420 to removably secure it in place (e.g., a press fit), such that the liquid 120 (see FIG. 3) passes through the filter assembly 950 during use. Once secured to the projection 420, the filter assembly 950 is prevented from exiting the open lower portion 432 of the supplement housing portion 400 by the projection 420 during normal usage by a user drinking liquid 120 that has passed through the filter assembly 950.

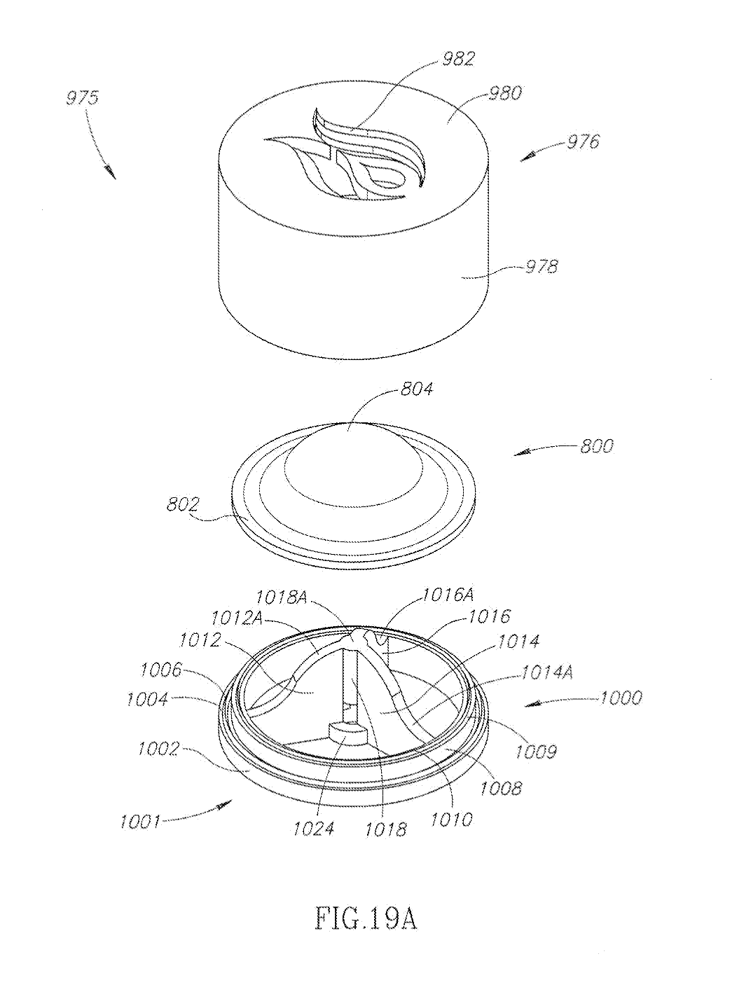

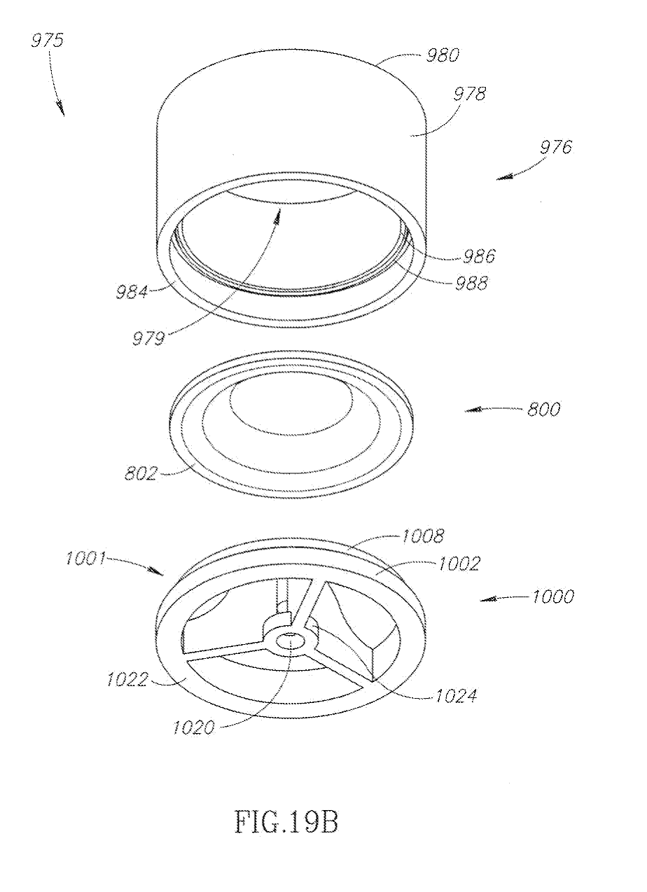

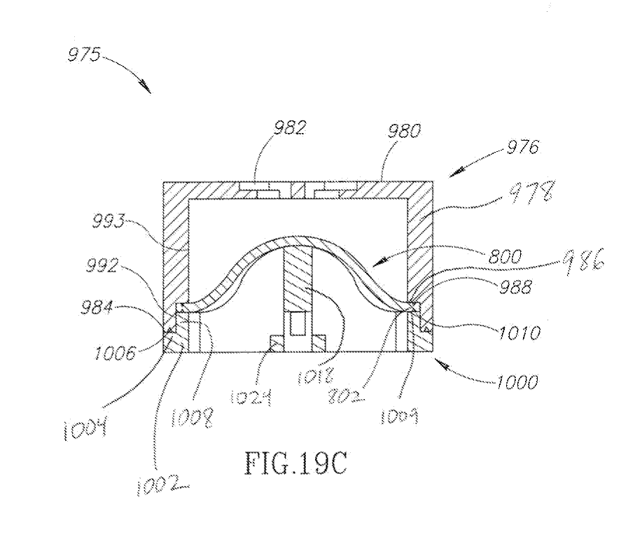

FIGS. 19A-19C illustrate various views of another embodiment of a filter assembly 975 that may be used with the supplement housing portion 400 shown in FIGS. 8A and 8B. The filter assembly 975 includes a body portion 976, a filter holder portion 1000, and the domed filter screen 800.

The filter holder portion 1000 comprises a perimeter portion 1001 that includes a lower circumferential sidewall 1002 having a top surface 1004 and a bottom surface 1022. The perimeter portion 1001 also includes a circumferential upper sidewall 1008 having a top surface 1009. As shown in FIG. 19C, the upper sidewall 1008 is positioned on top of the lower sidewall 1002, such that the inner diameters of these sidewalls are aligned.

The lower sidewall 1002 and the upper sidewall 1008 are coupled to inner portions 1018 and 1024 via three spoke portions 1012, 1014, and 1016, as shown in FIG. 19A. As shown best in FIG. 19B, the inner portion 1024 defines an aperture 1020 that is sized to receive the projection 420 of the supplement housing portion 400, so that the filter assembly 975 may be used as described above in relation to other embodiments.

Similar to previously described embodiments, the inner portion 1018 and the spoke portions 1012, 1014 and 1016 are shaped such that their top surfaces 1018A, 1012A, 1014A, and 1016A, respectively, together form a frame for the domed filter screen 800 configured to maintain the filter screen's shape during use.

The body portion 976 of the filter assembly 975 comprises a cylindrical sidewall 978 and a top portion 980 that together form an inner chamber 979 (see FIG. 19B) shaped to receive the domed filter screen 800 when in an assembled condition. The top portion 980 includes a plurality of openings 982 configured to permit liquid to pass therethrough. The sidewall 978 includes a bottom surface 984 configured to interface with the top surface 1004 of the filter holder portion 1000. The sidewall 978 also includes a downward facing circumferential surface 986 (see FIGS. 19B and 19C) configured to interface with the edge portion 802 of the filter screen 800 and the top surface 1009 of the holder portion when the filter assembly 975 is in the assembled condition.

During manufacturing, the filter screen 800 may be positioned on top of the filter holder portion 1000 such that a bottom surface of the edge portion 802 of the filter screen contacts the top surface 1009 of the filter holder portion. Further, the body portion 976 may be positioned over the filter screen 800 and the filter holder portion 1000 such that the bottom surface 984 of the body portion contacts the top surface 1004 of the filter holder portion and the downward facing surface 986 of the body portion contacts the edge portion 802 of the filter 800. The body portion 976, the filter holder portion 1000, and the filter screen 800 may be attached to each other by means of an ultrasonic welding process or other suitable process operative to couple the filter screen, the clamp rings, and body portion together. In this embodiment, the surface 986 of the body portion 976 and the surfaces 1004 and 1008 of the filter holder portion 1000 may each include circumferential spiked energy director portions 988, 1006, and 1010, respectively, to facilitate the joining of the surfaces during the ultrasonic welding process.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A supplement dispensing closure couplable to an outlet of a container housing a liquid, the closure comprising:
a supplement retention chamber and a liquid flow pathway extending through the supplement retention chamber, the liquid flow pathway being configured to guide a liquid exiting the container through the outlet through the supplement retention chamber when the closure is coupled to the container, the supplement retention chamber being configured to retain a dissolvable supplement body as the liquid flows therethrough and dissolves the dissolvable supplement body; and
a selectively removable filter assembly disposed within a portion of the liquid flow pathway before the supplement retention chamber, the filter assembly being operable to filter a liquid guided by the liquid flow pathway before the liquid flows through the supplement retention chamber.

2. The supplement dispensing closure of claim 1, wherein the filter assembly comprises a filter screen and a frame coupled together.

3. The supplement dispensing closure of claim 1, wherein the filter assembly comprises a single molded piece.

4. The supplement dispensing closure of claim 1, wherein the supplement retention chamber comprises:
a supplement chamber having an aperture configured to accommodate the passage of the dissolvable supplement body therethrough; and
a supplement stop portion adjacent the aperture of the supplement chamber configured to prevent the dissolvable supplement body from passing through the aperture of the supplement chamber, the supplement stop portion including an exit aperture positioned such that a liquid dissolving the dissolvable supplement body flows through the supplement chamber and out the exit aperture of the supplement stop portion,
wherein the supplement chamber comprises a perforated support platform opposite the supplement stop portion, the perforated support platform being positioned along the liquid flow pathway before the supplement retention area such that a liquid exiting the container through the outlet flows through the perforated support platform and into the supplement retention area when the closure is coupled to the container, and wherein the perforated support platform includes a downward extending projection;
wherein the filter assembly comprises an opening sized to receive the projection to permit selective coupling between the supplement chamber and the filter assembly.

5. The supplement dispensing closure of claim 1, wherein the filter assembly comprises a filter housing sized to removably receive a disposable filter.

6. The supplement dispensing closure of claim 5, wherein the filter housing comprises:
a body portion configured to be selectively coupled with the supplement dispensing closure; and
a lid portion configured for selective coupling with the body portion;
wherein a filter chamber sized to receive the disposable filter is formed between the body portion and the lid portion when coupled together.

7. The supplement dispensing closure of claim 6, wherein the body portion and the lid portion of the filter housing are configured for selective coupling together by a snap fit.

8. The supplement dispensing closure of claim 5, wherein the supplement retention chamber has a downwardly extending projection, and the body portion has an opening sized to receive the projection to permit selective coupling between the supplement retention chamber and the body portion.

9. The supplement dispensing closure of claim 5, wherein the disposable filter comprises activated carbon cloth (ACC).

10. The supplement dispensing closure of claim 5, wherein the disposable filter is dome shaped.

11. The supplement dispensing closure of claim 1, wherein the selectively removable filter assembly comprises a filter screen supported by a frame.

12. The supplemental dispensing closure of claim 11, wherein the filter screen is dome shaped.

13. The supplement dispensing closure of claim 1, wherein the supplement retention chamber has a downwardly extending projection, and the filter assembly has an opening sized to receive the projection to permit selective coupling between the supplement retention chamber and the filter assembly.

14. The supplement dispensing closure of claim 13, wherein the selectively removably filter assembly is non-planar in shape.

15. A filter assembly couplable to a closure cap of a container, the container having an outlet and a liquid flow pathway configured to guide a liquid exiting the container through the outlet, the closure cap having a downwardly extending projection, the filter assembly comprising:
a filter screen removably disposed within a portion of the liquid flow pathway before the outlet, the filter screen being operable to filter a liquid guided by the liquid flow pathway before the liquid flows through the outlet; and
a filter support portion configured to maintain the position of the filter screen and having an opening sized to receive the projection of the closure cap to permit selective coupling between the closure cap and the frame.

16. The filter assembly of claim 15, wherein the filter support portion comprises a filter housing sized to removably receive the filter screen.

17. The filter assembly of claim 16, wherein the filter housing comprises:
a body portion having the opening sized to receive the projection of the closure cap; and
a lid portion configured for selective coupling with the body portion;
wherein a filter chamber sized to receive the filter screen is formed between the body portion and the lid portion when coupled together.

18. The filter assembly of claim 17, wherein the body portion and the lid portion of the filter housing are configured for selective coupling together by a snap fit.

19. The filter assembly of claim 15, wherein the filter screen is non-planar in shape.

20. A supplement dispensing closure couplable to an outlet of a container housing a liquid, the closure comprising:
a supplement retention chamber and a liquid flow pathway extending through the supplement retention chamber, the liquid flow pathway being configured to guide a liquid exiting the container through the outlet through the supplement retention chamber when the closure is coupled to the container, the supplement retention chamber being configured to retain a dissolvable supplement body as the liquid flows therethrough and dissolves the dissolvable supplement body, the supplement retention chamber including a downwardly extending projection; and
a selectively removable filter assembly disposed within a portion of the liquid flow pathway before the supplement retention chamber, the filter assembly having an opening sized to receive the projection to permit selective coupling between the supplement retention chamber and the filter assembly, the filter assembly being operable to filter a liquid guided by the liquid flow pathway before the liquid flows through the supplement retention chamber.
